(19) United States
(12) Patent Application Publication
(10) Pub. No.: US 2026/0154518 A1
(43) Pub. Date: Jun. 4, 2026

(54) STORAGE MEDIUM STORING THREAD COLOR REGISTRATION PROGRAM, THREAD COLOR REGISTRATION METHOD, AND THREAD COLOR REGISTRATION SYSTEM

(71) Applicant: BROTHER KOGYO KABUSHIKI KAISHA, Nagoya (JP)

(72) Inventor: Daisuke ABE, Nagoya (JP)

(73) Assignee: BROTHER KOGYO KABUSHIKI KAISHA, Nagoya (JP)

(21) Appl. No.: 19/394,295

(22) Filed: Nov. 19, 2025

(30) Foreign Application Priority Data
Nov. 29, 2024 (JP) 2024-208990

(51) Int. Cl. G06K 7/10; D05C 5/02; G06K 7/14

(52) U.S. Cl. CPC G06K 7/10722; D05C 5/02; G06K 7/1417

(57) ABSTRACT

A non-transitory computer-readable storage medium stores a thread color registration program including a set of program instructions for a thread color registration device including an image sensor, a display, and a processor. The set of program instructions, when executed by the processor, causes the thread color registration device to perform detecting a two-dimensional code by the image sensor; in a registration list storing a first color of a first thread spool, storing a second color of a second thread spool different from the first thread spool, the second color being indicated by the two-dimensional code, the registration list being stored in a memory; and displaying a list image on the display, the list image indicating registered colors that are a plurality of colors stored in the registration list, the registered colors including the first color and the second color.

### SPECIFICATION

### REFERENCE TO RELATED APPLICATIONS

This application claims priority from Japanese Patent Application No. 2024-208990 filed on November 29, 2024. The entire content of the priority application is incorporated herein by reference.

### BACKGROUND ART

An embroidery data generating device generates embroidery data for performing embroidery by an embroidery machine.

### SUMMARY

An embroidery data generating device stores colors of threads. The embroidery data generating device reads color display data stored in an image data storage device in response to an operation such as designation of a color number, and stores the color of the thread. Alternatively, the embroidery data generating device reads the actual color from a scanner and stores the color of the thread. The embroidery data generating device displays an image indicating a finish of a pattern to be sewn using threads of the registered colors, based on the colors of the threads possessed by the user and registered in the embroidery data generating device. The embroidery data generating device receives a designation of a color of a thread to be used for sewing a pattern from among the colors of the threads registered in the embroidery data generating device.

In the embroidery data generating device, the operation of designating the color number requires the user to perform the operation while checking the color number, and there is a possibility that a human erroneous operation may occur. Reading the actual thread color with the scanner is not accurate because the embroidery data generating device may erroneously recognize a similar color depending on the external environment such as the brightness of the space.

In view of the foregoing, an example of an object of this disclosure is to provide a storage medium storing a thread color registration program, a thread color registration method, and a thread color registration system that contribute to storing (registering) the color of a thread possessed by a user easily and accurately and displaying the registered color.

According to a first aspect, this specification discloses a non-transitory computer- readable storage medium storing a thread color registration program including a set of program instructions for a thread color registration device including an image sensor, a display, and a processor. The set of program instructions, when executed by the processor, causes the thread color registration device to perform detecting a two-dimensional code by the image sensor. Thus, the two-dimensional code is detected by the image sensor. The set of program instructions, when executed by the processor, causes the thread color registration device to perform, in a registration list storing a first color of a first thread spool, storing a second color of a second thread spool different from the first thread spool. The second color is indicated by the two-dimensional code. The registration list is stored in a memory. Thus, the second color of the second thread spool different from the first thread spool is stored in the registration list. The set of program instructions, when executed by the processor, causes the thread color registration device to perform displaying a list image on the display. The list image indicates registered colors that are a plurality of colors stored in the registration list. The registered colors include the first color and the second color. Thus, the list image is displayed on the display.

The detecting and the storing of the thread color registration program of the first aspect contribute to storing (registering) the color of the thread possessed by the user in the registration list easily and accurately by using the two-dimensional code. The displaying of the thread color registration program contributes to allowing the user to grasp the colors of the threads that are possessed by the user and that are stored in the registration list.

According to a second aspect, this specification discloses a thread color registration method of registering a color of a thread spool. The method includes detecting a two-dimensional code by an image sensor. The method includes, in a registration list storing a first color of a first thread spool, storing a second color of a second thread spool different from the first thread spool. The second color is indicated by the two-dimensional code. The registration list is stored in a memory. The method includes displaying a list image on a display. The list image indicates registered colors that are a plurality of colors stored in the registration list. The registered colors include the first color and the second color. The thread color registration method of the second aspect has effects similar to those of the thread color registration program of the first aspect.

According to a third aspect, this specification discloses a thread color registration system. The thread color registration system includes a first thread spool, a second thread spool different from the first thread spool, a memory, an image sensor, a display, and a processor. The second thread spool has a two-dimensional code. The memory is configured to store a registration list for registering colors of threads of thread spools. The processor is configured to detect the two-dimensional code by the image sensor. The processor is configured to, in a registration list storing a first color of the first thread spool, store a second color of the second thread spool. The second color is indicated by the two-dimensional code. The processor is configured to display a list image on the display. The list image indicates registered colors that are a plurality of colors stored in the registration list. The registered colors include the first color and the second color. The thread color registration system of the third aspect has effects similar to those of the thread color registration program of the first aspect.

### BRIEF DESCRIPTION OF DRAWINGS

FIG. 1 illustrates a thread color registration system 4.

FIG. 2 is a block diagram showing an electrical configuration of a thread color registration device 1 and a server 5.

FIG. 3 illustrates a thread spool 80.

FIG. 4 is a flowchart of a list image display process.

FIG. 5A illustrates a registration screen G1 before image capturing.

FIG. 5B illustrates the registration screen G1 in a case where a second thread spool 82 is captured.

FIG. 5C illustrates the registration screen G1 in a case where five thread spools 80 including thread spools 82 and 83 are captured.

FIG. 6A illustrates a registration list 141 before a list image display process of examples 1 to 4 is performed.

FIG. 6B illustrates the registration list 141 updated based on a capturing result of the second thread spool 82.

FIG. 6C illustrates the registration list 141 updated based on capturing results of the five thread spools 80 including the thread spools 82 and 83.

FIG. 6D illustrates the registration list 141 updated based on a capturing result of the second thread spool 82.

FIG. 6E illustrates the registration list 141 updated based on a capturing result of the second thread spool 82.

FIG. 7 illustrates a screen G6.

FIG. 8 is a flowchart of a pattern image display process performed by the thread color registration device 1 and a pattern image transmission process performed by the server 5.

FIG. 9A illustrates a screen F1 showing an extraction result when a pattern is extracted with a keyword “Flower”.

FIG. 9B illustrates a screen F5 for selecting a condition for extracting a pattern represented by a color stored in the registration list 141.

FIG. 9C illustrates a screen F8 showing an extraction result in a case where a pattern is extracted under the extraction condition shown in FIG. 9B.

FIG. 10 is a flowchart of a pattern color list image display process.

FIG. 11 is a flowchart of a pattern color replacement process.

FIG. 12A illustrates a screen H1 displayed before the pattern color replacement process is performed.

FIG. 12B illustrates a screen H6 displayed after the pattern color replacement process is performed.

FIG. 13A illustrates a thread-spool case 69 of a system 4 and a plurality of thread spools 80 housed in the thread-spool case 69.

FIG. 13B is a cross-sectional view of the thread-spool case 69 that houses the plurality of thread spools 80.

FIG. 14 illustrates a list image J.

### DESCRIPTION

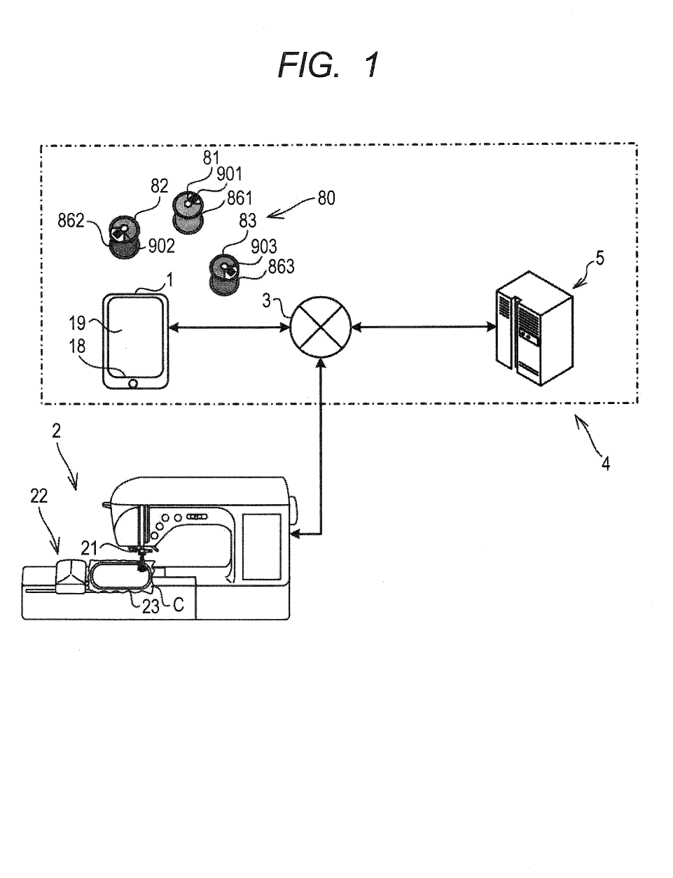

Embodiments of the present disclosure will be described with reference to the drawings. As shown in FIG. 1, a thread color registration system 4 includes a thread color registration device 1, a server 5, and a plurality of thread spools 80. Hereinafter, the thread color registration system 4 is referred to as a “system 4”. The thread color registration device 1 is configured to communicate with each of a sewing machine 2 and the server 5 via a network 3. The sewing machine 2 includes a needle bar 21 and a movement mechanism (carriage) 22, and is configured to perform embroidery sewing.

The thread color registration device 1 has a function of selecting a pattern to be sewn by the sewing machine 2 and transmitting information relating to the selected pattern to the sewing machine 2. The information relating to the selected pattern is, for example, pattern data indicating the selected pattern. The pattern data includes an ID for identifying a pattern, pattern image data indicating the pattern, and sewing data for sewing the pattern. The pattern image data is data in which the color of each pixel is expressed by a gradation value in an RGB color space of red (R), green (G), and blue (B). The color space adopted by the pattern image data may be other than the RGB color space. The sewing data includes coordinate data and color data. The coordinate data is data that indicates formation positions of stitches included in the pattern, that is, the positions of the needle drop points, by coordinates of the embroidery coordinate system. The color data indicates the color of the thread for sewing the pattern, that is, the pattern color.

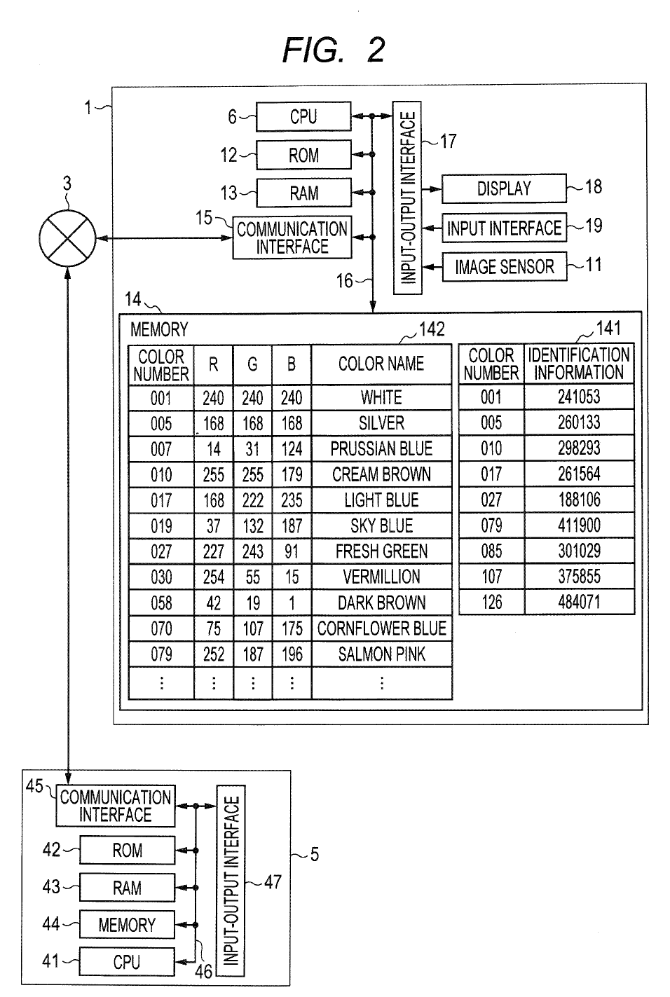

The thread color registration device 1 is a tablet-type portable terminal device or a smartphone. As shown in FIG. 2, the thread color registration device 1 includes a CPU 6, a ROM 12, a RAM 13, a memory 14, a communication interface 15, an input-output (I/O) interface 17, an image sensor 11, a display 18, and an input interface 19.

The CPU 6 controls the thread color registration device 1. The CPU 6 is electrically connected to the ROM 12, the RAM 13, the memory 14, the communication interface 15, and the input-output interface 17 via a bus 16. Various programs and setting values are stored in the ROM 12. The CPU 6 stores temporary data in the RAM 13.

The memory 14 is a non-volatile storage device such as a flash memory. The memory 14 stores various setting values used for performing processing described later. The memory 14 stores a registration list 141 and a color list 142. The registration list 141 stores the color of a thread 86 of the thread spool 80 based on the detection result of a two-dimensional code 90 by the image sensor 11. In the registration list 141 of the present embodiment, a color number indicating the color of the thread 86 of the thread spool 80 and identification information of the thread spool 80 are stored in association with each other. In the registration list 141, either the color number or the identification information may be stored.

The color list 142 stores colors that can be stored (registered) in the registration list 141. Among colors that can be stored in the registration list 141, a color stored in the registration list 141 is defined as a registered color, and a color not stored in the registration list 141 is defined as an unregistered color. The color list 142 according to the present embodiment stores registered colors and unregistered colors. The color list 142 stores a color number, RGB values, and a color name in association with each other. The color list 142 may store other information.

The communication interface 15 is an interface for connecting the thread color registration device 1 to the network 3. The CPU 6 transmits and receives data to and from other devices connected to the network 3, such as the sewing machine 2 and the server 5, via the communication interface 15. The input-output interface 17 is connected to the display 18, the input interface 19, and the image sensor 11.

The display 18 is, for example, a liquid crystal display. The input interface 19 is, for example, a touch screen, and is used for inputting various instructions. When the user operates the input interface 19, the input interface 19 outputs a signal corresponding to the operation of the user to the CPU 6. The image sensor 11 is a digital camera including an imaging element such as a CCD or a CMOS and an imaging lens. For example, when the user captures an image of the thread spool 80 in the real space by the image sensor 11, the image sensor 11 outputs an image indicating the thread spool 80.

As shown in FIG. 1, the sewing machine 2 drives the needle bar 21 in an upper-lower direction in accordance with the sewing data, in conjunction with an embroidery frame 23 being moved in a front-rear direction and a left-right direction by the movement mechanism 22. The sewing machine 2 thereby sews a pattern on a sewing workpiece C held by the embroidery frame 23. The sewing workpiece C is a fabric, for example.

The server 5 is configured to communicate with at least the thread color registration device 1. As shown in FIG. 2, the server 5 includes a CPU 41, a ROM 42, a RAM 43, a memory 44, a communication interface 45, and an input-output (I/O) interface 47. The CPU 41 is electrically connected to the ROM 42, the RAM 43, the memory 44, the communication interface 45, and the input-output interface 47 via a bus 46.

The CPU 41 is responsible for controlling the server 5. The ROM 42 stores a boot program and a basic input-output system (BIOS). The CPU 41 stores temporary data in the RAM 43. The memory 44 is a nonvolatile storage device, and stores pattern data of a plurality of types of patterns.

The communication interface 45 is an interface for connecting the server 5 to the network 3. The CPU 41 transmits and receives data to and from other devices connected to the network 3, such as the sewing machine 2 and the thread color registration device 1, via the communication interface 45. The server 5 is configured to, in response to receiving a request for transmitting pattern data from the thread color registration device 1, transmit the pattern data corresponding to the request among the pattern data stored in the memory 44 to the thread color registration device 1.

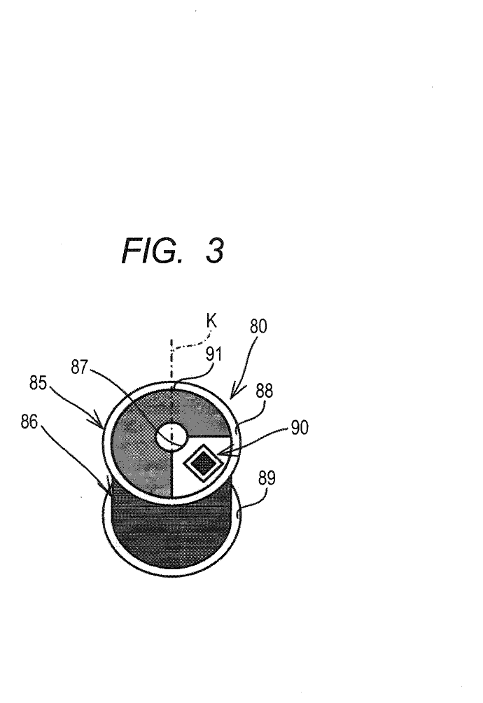

In the present embodiment, a pattern selected by the thread color registration device 1 is sewn by the sewing machine 2 by using thread spools. These thread spools are collectively referred to as thread spools 80. As shown in FIG. 3, the thread spool 80 includes a cylindrical body 85 and a thread 86 wound around the outer circumference of the cylindrical body 85. The cylindrical body 85 has a cylindrical shape having a through hole 87 and flanges 88 and 89. The through hole 87 extends in the longitudinal direction of the cylindrical body 85. The flanges 88 and 89 are disposed at both ends of the cylindrical body 85 in the longitudinal direction.

A label 91 including a two-dimensional code 90 is affixed to the surface of the flange 88. The back surface of the flange 88 is a surface in a direction in which the thread 86 and the flange 89 are located with respect to the flange 88 in the direction along an axis K of the through hole 87. The front surface of the flange 88 is a surface in a direction in which the thread 86 and the flange 89 are not located with respect to the flange 88.

The two-dimensional code 90 may be appropriately selected from various codes including a QR Code, a VeriCode, a CP Code, an AztecCode, and a PDF417. The two-dimensional code 90 of the present embodiment is a QR code. The two-dimensional code 90 indicates the color of the thread 86 of the thread spool 80. The “QR Code” is a registered trademark of DENSO WAVE INCORPORATED.

The two-dimensional code 90 of the present embodiment indicates the color of the thread 86 of the thread spool 80 and also indicates identification information that uniquely identifies the thread spool 80. The identification information is, for example, a serial number represented by a six digit number. The two-dimensional code 90 indicates the color number and the identification information in the format of “color number_serial number”, for example. The three digit number before the underscore indicates the color number, and the six digit number after the underscore indicates the identification information.

As shown in FIG. 1, the plurality of thread spools 80 include a first thread spool 81, a second thread spool 82, and a third thread spool 83. The second thread spool 82 is a thread spool different from the first thread spool 81. The third thread spool 83 is a thread spool different from the first thread spool 81 and the second thread spool 82. Hereinafter, when the thread spools 80 are individually described, the first thread spool 81, the second thread spool 82, and the third thread spool 83 are used.

The first thread spool 81 has a thread 861. The color of the thread 861 of the first thread spool 81 is also referred to as a first color. The second thread spool 82 has a thread 862. The color of the thread 862 of the second thread spool 82 is also referred to as a second color. The third thread spool 83 has a thread 863. The color of the thread 863 of the third thread spool 83 is also referred to as a third color.

The first thread spool 81 has a two-dimensional code 901. The second thread spool 82 has a two-dimensional code 902. The third thread spool 83 has a two-dimensional code 903. The number of thread spools 80 included in the plurality of thread spools 80 may be changed as appropriate.

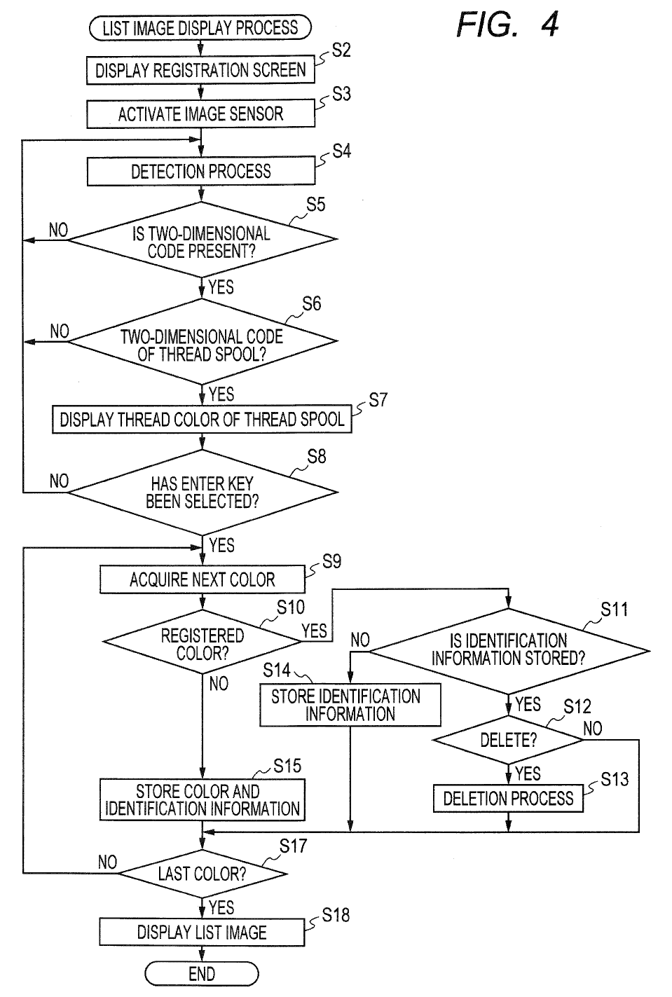

In the present embodiment, a list image display process performed by the thread color registration device 1 will be described with reference to FIGS. 4 to 7. When the user registers the color of the thread spool 80 in the registration list 141 based on the two-dimensional code 90, the user operates the input interface 19 to input an instruction to start the list image display process. The CPU 6 detects an instruction to start the list image display process based on the signal output from the input interface 19. In response to detecting the instruction to start the list image display process, the CPU 6 reads out a program for performing the list image display process stored in a program storage area of the memory 14 to the RAM 13. The program includes instructions for causing the CPU 6 to execute the following processing. The CPU 6 executes the following steps according to the instructions included in the program read out to the RAM 13. Hereinafter, a step is abbreviated as S.

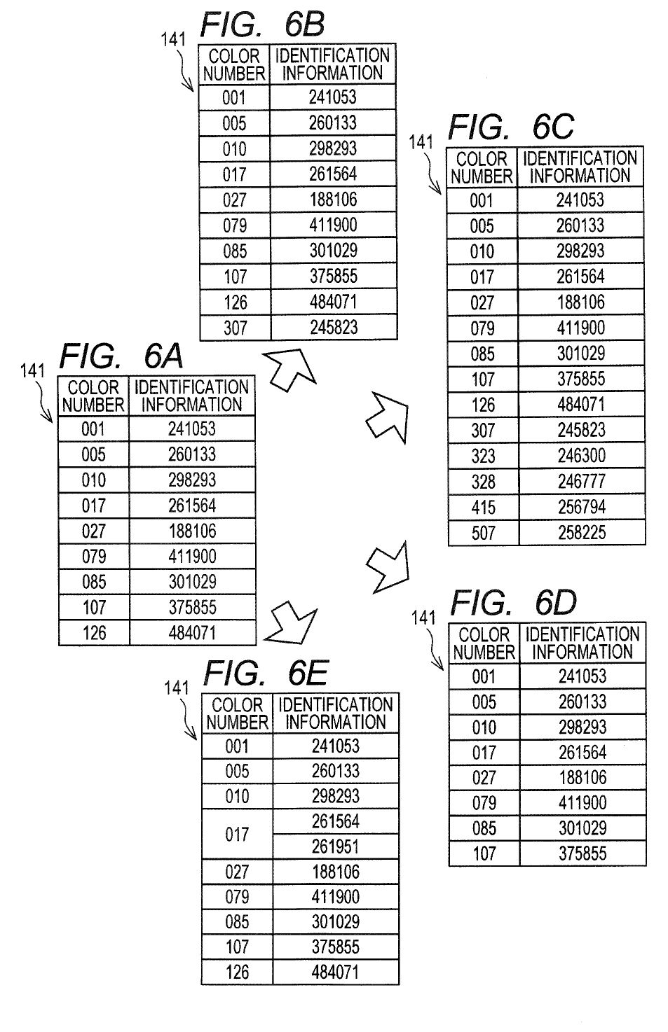

FIG. 6A shows the registration list 141 at the time of starting execution of the list image display process. In the registration list 141 of FIG. 6A, the identification information and the color numbers of the nine thread spools 80 including the first thread spool 81 are stored by the past list image display process performed before the current list image display process is started. In the present embodiment, the CPU 6 stores the color of the thread 862 of the second thread spool 82 in the registration list 141.

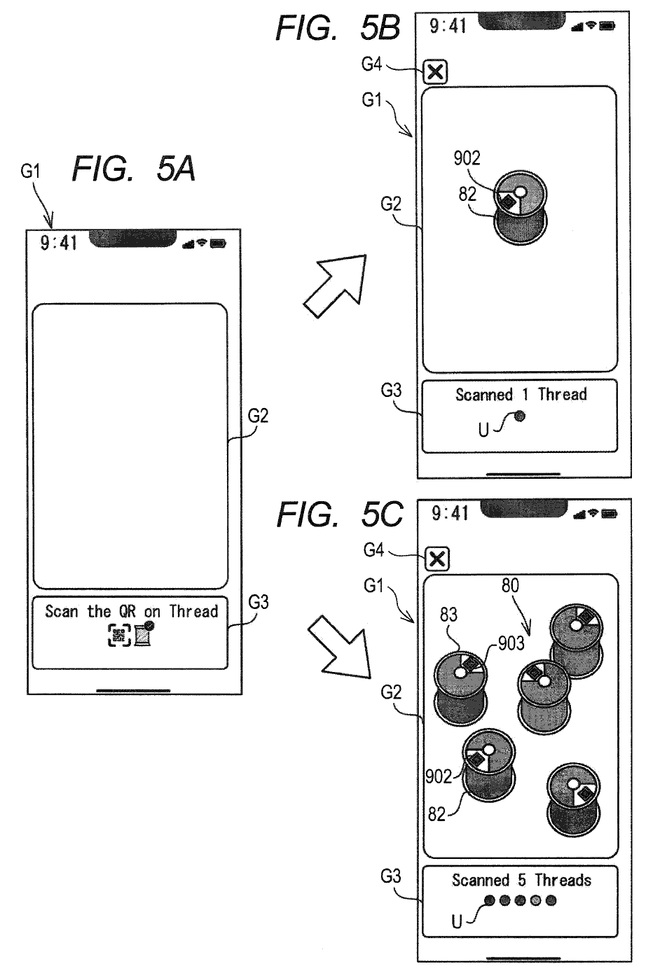

As shown in FIG. 4, the CPU 6 controls the display 18 to display a registration screen G1 including an image output by the image sensor 11 (S2). FIG. 5A illustrates a registration screen G1 before the image sensor 11 is activated. As shown in FIG. 5A, the registration screen G1 includes fields G2 and G3. The field G2 displays a captured image output by the image sensor 11. The field G3 displays the color of the thread 86 of the thread spool 80 indicated by the two-dimensional code 90 detected from the captured image displayed in the field G2 and the number of colors. The CPU 6 displays, in the field G3, a message for prompting the user to read the two-dimensional code.

The CPU 6 activates the image sensor 11 to display the captured image in the field G2 (S3). The user captures the thread spool 80 to be registered with the image sensor 11 in accordance with the message in the field G3. That is, the user directs the imaging lens of the image sensor 11 toward the thread spool 80 to be registered and captures an image. The CPU 6 displays, in the field G2, the captured image output by the image sensor 11, that is, the image indicating the thread spool 80 to be registered. In the present embodiment, the image sensor 11 is automatically activated after S2, but the image sensor 11 may be activated at any timing by the user operating the input interface 19.

The CPU 6 performs a detection process to detect the two-dimensional code (S4). In the detection process, the CPU 6 detects the two-dimensional code when the two-dimensional code is present in the captured image displayed in the field G2. For example, when a QR Code is used as the two-dimensional code, the CPU 6 may detect the two-dimensional code by using pattern detection of the same cutout symbols arranged at three corners among four corners of the QR Code in the captured image. When no two-dimensional code is present in the captured image displayed in the field G2, the two-dimensional code is not detected. When a plurality of two-dimensional codes are present in the captured image displayed in the field G2, the plurality of two-dimensional codes are detected.

The CPU 6 determines whether a two-dimensional code has been detected in S4 (S5). In response to determining that the two-dimensional code has not been detected (S5: NO), the CPU 6 returns the processing to S4. In response to determining that the two-dimensional code has been detected (S5: YES), the CPU 6 advances the processing to S6.

The CPU 6 determines whether the two-dimensional code detected in S4 is the two-dimensional code 90 of the thread spool 80 (S6). The method of determining in S6 may be set as appropriate. The CPU 6 decodes the detected two-dimensional code, for example, and acquires the number indicated by the two-dimensional code. When the three digit number before the underscore in the number indicated by the two-dimensional code is stored as the color number in the color list 142, the CPU 6 determines that the detected two-dimensional code is the two-dimensional code 90 of the thread spool 80. When the detected two-dimensional code is not the two-dimensional code 90 of the thread spool 80 (S6: NO), the CPU 6 returns the processing to S4.

In response to determining that the two-dimensional code detected in S4 is the two-dimensional code 90 of the thread spool 80 (S6: YES), the CPU 6 advances the processing to S7. The CPU 6 displays, in the field G3, the color of the thread 86 indicated by the two-dimensional code 90 of the thread spool 80 and the number of colors (S7). The color of the thread 86 is acquired by, for example, referring to the color list 142 and identifying the RGB values corresponding to the color number indicated by the two-dimensional code 90. The number of colors is acquired by calculating the number of colors having different color numbers in the color numbers indicated by the two-dimensional code 90, for example. As shown in FIG. 5B, the color of the thread 86 is displayed by a circular icon U of the color of the thread 86. The number of colors of the thread 86 is displayed numerically above the circular icon of the color of the thread 86. The CPU 6 displays an enter key G4.

The CPU 6 determines whether selection of the enter key G4 has been detected based on the signal output from the input interface 19 (S8). The user checks the display of the field G3, and when the user wishes to register the color displayed in the field G3 in the registration list 141, the user operates the input interface 19 to select the enter key G4. When selection of the enter key G4 is not detected (S8: NO), the CPU 6 returns the processing to S4.

In response to detecting selection of the enter key G4 (S8: YES), the CPU 6 acquires the next color in the order of acquisition of the colors of the thread 86 of the thread spool 80 corresponding to the two-dimensional code 90 detected in S4 (S9). The order of acquisition may be set as appropriate, and may be, for example, ascending order of the color number of the color of the thread 86.

The CPU 6 determines whether the color acquired in S9 is a registered color that has already been registered in the registration list 141 (S10). When the color number of the acquired color of the thread 86 matches any one of the color numbers stored in the registration list 141, the CPU 6 determines that the color of the thread 86 is the registered color that is stored in the registration list 141. When the color number of the acquired color of the thread 86 does not match any one of the color numbers stored in the registration list 141, the CPU 6 determines that the color of the thread 86 is an unregistered color that is not stored in the registration list 141. In response to determining that the color number of the color of the thread 86 is the registered color that is stored in the registration list 141 (S10: YES), the CPU 6 advances the processing to S11. In response to determining that the color number of the color of the thread 86 is not the registered color that is stored in the registration list 141, that is, the color number of the color of the thread 86 is the unregistered color (S10: NO), the CPU 6 advances the processing to S15.

The CPU 6 determines whether the identification information indicated by the two-dimensional code 90 is stored in the registration list 141 (S11). When the identification information indicated by the two-dimensional code 90 matches any one of the identification information corresponding to the color of the thread 86 stored in the registration list 141, the CPU 6 determines that the identification information indicated by the two-dimensional code 90 is stored in the registration list 141. When the identification information indicated by the two-dimensional code 90 does not match any one of the identification information corresponding to the color of the thread 86 stored in the registration list 141, the CPU 6 determines that the identification information indicated by the two-dimensional code 90 is not stored in the registration list 141. When the identification information indicated by the two-dimensional code 90 is stored in the registration list 141 (S11: YES), the CPU 6 advances the processing to S12. When the identification information indicated by the two-dimensional code 90 is not stored in the registration list 141 (S11: NO), the CPU 6 performs a registration process of storing (registering), in the registration list 141, the identification information indicated by the two-dimensional code 90 in association with the color of the thread 86 stored in the registration list 141 (S14).

When the color number of the color of the thread 86 is an unregistered color (S10: NO), the CPU 6 performs a registration process of storing (registering), in the registration list 141, the color of the thread 86, which is the color indicated by the two-dimensional code 90, and the identification information of the thread spool 80 in association with each other (S15). When the color of the thread 86 is not stored in the registration list 141, the identification information of the thread spool 80 is not stored in the registration list 141. That is, the CPU 6 stores, in the registration list 141, the identification information of the thread spool 80 in association with the color of the thread 86.

When the identification information indicated by the two-dimensional code 90 is stored in the registration list 141 (S11: YES), the CPU 6 determines whether to delete the identification information indicated by the two-dimensional code 90 from the registration list 141 (S12). The CPU 6 displays a screen for confirming whether to delete the identification information indicated by the two-dimensional code 90 from the registration list 141 on the display 18. The screen for confirming the deletion includes, for example, the identification information indicated by the two-dimensional code 90, a message “Do you want to delete this identification information from the registration list?”, and selection buttons such as “YES” and NO”. The user operates the input interface 19 to input an instruction as to whether to delete the identification information indicated by the two-dimensional code 90 from the registration list 141. The CPU 6 determines whether to delete the identification information indicated by the two-dimensional code 90 from the registration list 141 based on an input result of the input interface 19.

In response to determining that the identification information indicated by the two-dimensional code 90 is to be deleted from the registration list 141 (S12: YES), the CPU 6 performs an identification information deletion process of deleting the identification information indicated by the detected two-dimensional code 90 from the registration list 141 (S13). In a case where the number of identification information indicated by the two-dimensional code 90, that is, the number of identification information corresponding to the color of the thread 86 stored in the registration list 141 is one before S13 is performed, the CPU 6 also deletes the color number of the color of the thread 86 from the registration list 141 together with the identification information.

In response to determining that the identification information indicated by the two-dimensional code 90 is not to be deleted from the registration list 141 (S12: NO), the CPU 6 performs S17.

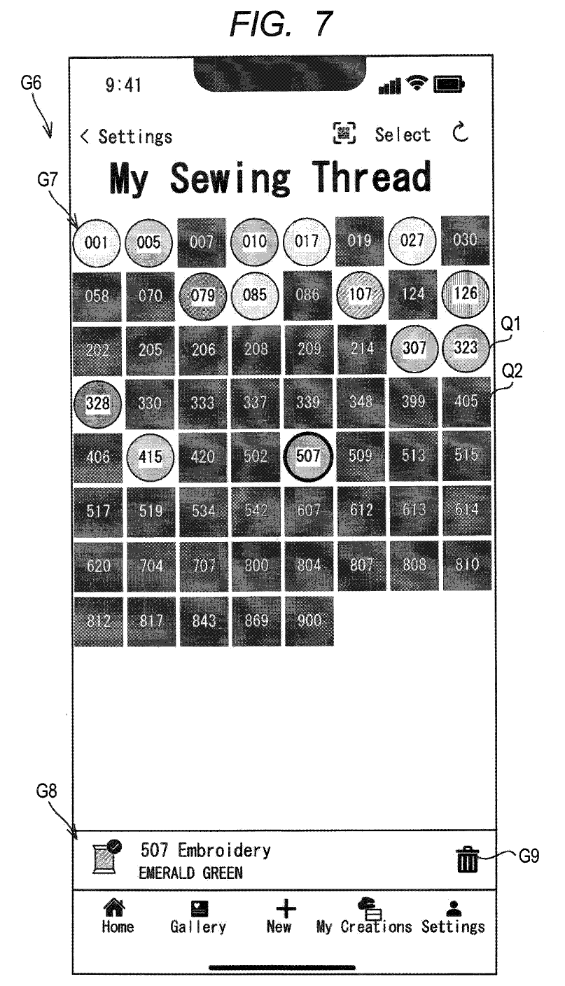

After S13, S14 or S15, the CPU 6 determines whether the color acquired in S9 is the last color in the order of acquisition (S17). When the color acquired in S9 is not the last color in the order of acquisition (S17: NO), the CPU 6 returns the processing to S9. When the color acquired in S9 is the last color in the order of acquisition (S17: YES), the CPU 6 advances the processing to S18. For example, in a case where the colors of the thread 86 of the thread spool 80 corresponding to the two-dimensional code 90 detected in S4 are acquired in ascending order of the color number and no more color is acquired, the CPU 6 determines that the color acquired in S9 is the last color in the order of acquisition. The CPU 6 performs a display process of controlling the display 18 to display a list image indicating registered colors as shown in FIG. 7 (S18). The registered colors are a plurality of colors stored in the registration list 141. The CPU 6 then ends the list image display process.

The list image display process will be described in order of examples 1 to 4. In the examples 1 to 4, the first thread spool 81 is the thread spool 80 indicated by the color number “001” and the identification information “241053”. That is, the first color is a color indicated by the color number “001”. FIG. 6A shows the registration list 141 before the list image display process is performed. The color number “001” of the first color and the identification information “241053” of the first thread spool 81 are stored in the registration list 141 before the list image display process is performed.

The first example will be described. The first example is an example in which the second color and the identification information corresponding to the second color are stored in the registration list 141 in a case where the color of the thread 862 of the second thread spool 82 corresponding to the detected two-dimensional code 902 is not the registered color that is stored in the registration list 141, that is, in a case where the second color is an unregistered color. In the first example, the second thread spool 82 is the thread spool 80 indicated by the color number “307” and the identification information “245823”. That is, the second color is a color indicated by the color number “307”.

The user captures an image of the second thread spool 82 with the image sensor 11 activated in S3. As shown in FIG. 5B, the CPU 6 displays an image showing the second thread spool 82 in the field G2.

In S4, the CPU 6 detects the two-dimensional code 902 of the second thread spool 82. The CPU 6 determines that the two-dimensional code 902 of the second thread spool 82 has been detected (S5: YES, S6: YES), and displays the second color and the number of detected colors in the field G3 (S7). As shown in FIG. 5B, the CPU 6 displays a circular icon U of the second color and the number of detected colors “1” in the field G3.

In response to detecting selection of the enter key G4 (S8: YES), the CPU 6 determines whether the color number “307” of the color of the thread 862 is a registered color (S10). As shown in FIG. 6A, the color number “307” of the second color is not stored in the registration list 141. The CPU 6 determines that the second color is an unregistered color (S10: NO), and performs a registration process of storing the color number “307” of the second color, which is the color indicated by the two-dimensional code 902, and the identification information “245823” of the second thread spool 82 in association with each other in the registration list 141 in which the color number “001” of the first color is stored (S15).

When the second color is not stored in the registration list 141, the identification information of the second thread spool 82 is not stored in the registration list 141. Thus, in S15, the CPU 6 stores the identification information of the second thread spool 82 in the registration list 141 in association with the second color. As shown in FIG. 6B, the CPU 6 stores the color number “307” of the second color and the identification information “245823” of the second thread spool 82 at the end of the registration list 141. Entries (items) of the registration list 141 may be stored in the order of storage time or in the ascending order of color number.

In S18, the registered colors include each of colors that are stored in the registration list 141 before the list image display process is performed and a color that is newly stored. In the example 1, the registered color includes the first color and the second color. The CPU 6 performs a display process of displaying, on the display 18, a list image indicating registered colors including the first color indicated by the color number “001” and the second color indicated by the color number “307” (S18).

Next, the second example will be described. The description of the same processing as that of the example 1 will be omitted. The second example is an example in which the second color and the identification information corresponding to the second color are deleted from the registration list 141 in a case where the color of the thread 862 of the second thread spool 82 corresponding to the detected two-dimensional code 902 is the registered color that is stored in the registration list 141, that is, in a case where the second color is the registered color. In the second example, the second thread spool 82 is the thread spool 80 indicated by the color number “126” and the identification information “484071”. That is, the second color is a color indicated by the color number “126”.

As shown in FIG. 6A, the color number “126” of the second color is stored in the registration list 141. In S10, the CPU 6 determines that the second color indicated by the color number “126” is a registered color (S10: YES), and advances the processing to S11.

The CPU 6 determines whether the identification information indicated by the two-dimensional code 902 is stored in the registration list 141 (S11). As shown in FIG. 6A, the identification information “484071” indicated by the two-dimensional code 902 is registered in the registration list 141. The CPU 6 determines that the identification information “484071” indicated by the two-dimensional code 902 is stored in the registration list 141 (S11: YES).

After S11, in response to determining that the identification information “484071” indicated by the two-dimensional code 902 is to be deleted from the registration list 141 (S12: YES), the CPU 6 performs an identification information deletion process of deleting the identification information “484071” indicated by the detected two-dimensional code 902 from the registration list 141 (S13). The CPU 6 deletes the identification information “484071” of the second thread spool 82 from the registration list 141. As shown in FIG. 6A, before S13 is performed, the identification information corresponding to the color number “126” stored in the registration list 141 is one identification information, which is “484071”. In this case, as shown in FIG. 6D, the CPU 6 deletes the color number “126” of the second color indicated by the two-dimensional code 902 from the registration list 141 together with the identification information “484071”.

In the example 2, in S18, the registered colors include the first color and do not include the second color. The registered colors are colors acquired by excluding the color deleted in S13 from the colors stored in the registration list 141 before the list image display process is performed. The CPU 6 performs the display process of displaying, on the display 18, a list image indicating registered colors including the first color indicated by the color number “001” and not including the second color indicated by the color number “126” (S18).

Next, the third example will be described. The description of the same processing as in the examples 1 and 2 will be omitted. In the example 3, the color of the thread 862 of the second thread spool 82 corresponding to the detected two-dimensional code 902 is a registered color that is stored in the registration list 141. That is, the second color is a registered color. However, the identification information indicated by the two-dimensional code 902 of the second thread spool 82 is not stored in the registration list 141. That is, the third example is an example in which, when the second color is the registered color and the identification information of the second thread spool 82 is not registered in the registration list 141, the identification information of the second thread spool 82 is additionally stored in the registration list 141 in association with the second color. In the example 3, the second thread spool 82 is the thread spool 80 indicated by the color number “017” and the identification information “261951”. That is, the second color is a color indicated by the color number “017”.

As shown in FIG. 6A, the color number “017” of the second color is stored in the registration list 141. In S10, the CPU 6 determines that the second color indicated by the color number “017” is a registered color (S10: YES), and advances the processing to S11.

The CPU 6 determines whether the identification information indicated by the two-dimensional code 902 is stored in the registration list 141 (S11). As shown in FIG. 6A, the identification information “261951” indicated by the two-dimensional code 902 is not stored in the registration list 141. The CPU 6 determines that the identification information “261951” indicated by the two-dimensional code 902 is not stored in the registration list 141 (S11: NO).

The CPU 6 performs a registration process of storing (registering) the identification information “261591” of the second thread spool 82 in the registration list 141 in association with the second color “017” (S14). As shown in FIG. 6E, in S14, the second color “017” is stored in the registration list 141 in association with two identification information “261564” and “261951”. The CPU 6 performs a display process of displaying, on the display 18, a list image indicating registered colors including the first color indicated by the color number “001” and the second color indicated by the color number “017” (S18). In the example 3, the registered colors included in the list image are the same before and after the registration process.

Next, the fourth example will be described. The description of the same processing as that of the example 1 will be omitted. As shown in FIG. 5C, the fourth example is an example in which the color of the thread 86 of each of the five thread spools 80 including the second thread spool 82 and the third thread spool 83 is stored in the registration list 141. In the fourth example, the second thread spool 82 is the thread spool 80 indicated by the color number “307” and the identification information “245823”. That is, the second color is a color indicated by the color number “307”. The third thread spool 83 is the thread spool 80 indicated by the color number “323” and the identification information “246300”. That is, the third color is a color indicated by the color number “323”. The colors of the other three thread spools 80 are the colors indicated by the color numbers “328”, “415”, and “507”, and the identification information of the respective thread spools 80 is “246777”, “256794”, and “258225”.

The user captures an image of the five thread spools 80 including the second thread spool 82 and the third thread spool 83 with the image sensor 11 activated in S3. As shown in FIG. 5C, the CPU 6 displays an image indicating five thread spools 80 including the second thread spool 82 and the third thread spool 83 in the field G2.

In S4, the CPU 6 detects the five two-dimensional codes 90 of the five thread spools 80. In the detection process of S4, in a case where the image displayed in the field G2 includes a plurality of two-dimensional codes, the CPU 6 detects each of the plurality of two-dimensional codes. The five two-dimensional codes 90 include the two-dimensional code 902 of the second thread spool 82 and the two-dimensional code 903 of the third thread spool 83.

Since all the detected two-dimensional codes are the two-dimensional codes 90 of the thread spools 80 (S6: YES), the CPU 6 displays five colors indicated by the detected five two-dimensional codes 90 and the number of colors in the field G3 (S7). As shown in FIG. 5C, the circular icons U of five colors and the number of colors “5” are displayed in the field G3.

In response to detecting selection of the enter key G4 (S8: YES), the CPU 6 performs processing from S9 to S17 for each of the five colors. The five colors include a second color and a third color. As shown in FIG. 6A, the color numbers of the five colors including the color number “307” of the second color and the color number “323” of the third color are not stored in the registration list 141. Thus, in the fourth example, when the CPU 6 determines whether each of the five colors is a registered color (S10), it is determined that all of the five colors including the second color and the third color are unregistered colors (S10: NO).

The CPU 6 performs a registration process of storing the color number and the identification information for each of the five thread spools 80 in the registration list 141 in which the color number “001” of the first color is stored (S15). The color numbers and the identification information of the five thread spools 80 include the color number “307” of the second color and the identification information “245823” of the second thread spool 82, and the color number “323” of the third color and the identification information “246300” of the third thread spool 83. As shown in FIG. 6C, the CPU 6 stores the color numbers “307”, “323”, “328”, “415”, and “507” and the identification information “245823”, “246300”, “246777”, “256794”, and “258225” at the end of the registration list 141.

In the example 4, in S18, the registered colors include the colors stored in the registration list 141 before the list image display process is performed and the colors that are newly stored. The registered colors include the first color, the second color, and the third color. The CPU 6 performs a display process of displaying, on the display 18, a list image indicating registered colors including the first color indicated by the color number “001”, the second color indicated by the color number “307”, and the third color indicated by the color number “323” (S18).

A list image displayed in S18 will be described by taking a screen G6 of the fourth example shown in FIG. 7 as an example. In the examples 1 to 3, the screen configuration is the same as that of the screen G6 of the example 4, but the registered color at the time of performing S18 is changed, and thus the colors indicated by the list image G7 are different. The screen G6 includes a list image G7, a field G8, and a key image G9. The list image G7 displays the registered colors and the unregistered colors in a visually distinguishable manner.

Specifically, the list image G7 of the present embodiment indicates the registered colors and the unregistered colors by color numbers which are numbers indicating colors. In the list image G7 of the present embodiment, the background of the color number of the registered color is shown in the registered color itself, and the background of the color number of the unregistered color is shown in gray. The CPU 6 may refer to the color list 142 and acquire the RGB values corresponding to the color number, thereby indicating the background of the color number of the registered color with the registered color. The list image G7 indicates the registered color by a first icon Q1 of the registered color, and indicates the unregistered color by a second icon Q2 having a shape different from that of the first icon Q1.

The first icon Q1 of the present embodiment is circular and the second icon Q2 is square. The first icon Q1 is painted in the registered color, and in order to enhance visibility, the color number is shown in black, and the periphery of the color number is painted in white in a rectangular shape. The second icon Q2 is filled with gray, and the color number is shown in white. In the example 4, the registered colors include the first color, the second color, and the third color. The list image G7 shows the first color, the second color, and the third color. That is, as shown in FIG. 7, the list image G7 shows colors corresponding to the color numbers “001”, “307”, and “323”.

The field G8 displays the color number and the color name of the color selected from the colors displayed in the list image G7. In FIG. 7, the color of the color name “EMERALD GREEN” of the color number “507” is selected and displayed. In the list image G7, the outline of the first icon Q1 corresponding to the color number “507” is indicated by a thick line. That is, it is indicated that the color corresponding to the color number “507” is selected in the list image G7. The user selects a desired color from the colors displayed in the list image G7 by operating the input interface 19.

The key image G9 is used to input an instruction to delete the color that is being selected (referred to as “currently selected color”) from the registration list 141. When the user operates the input interface 19 to select the key image G9, the color number and the identification information of the currently selected color are deleted from the registration list 141. When a plurality of identification information of the currently selected color are stored, all the identification information of the currently selected color may be deleted, or particular identification information may be deleted from the plurality of identification information of the currently selected color.

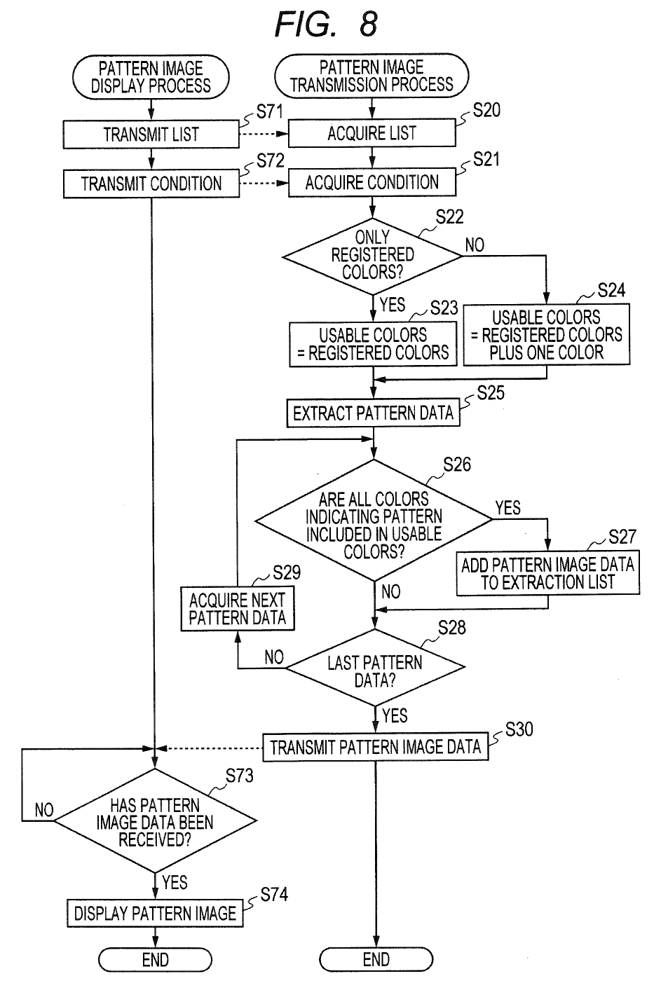

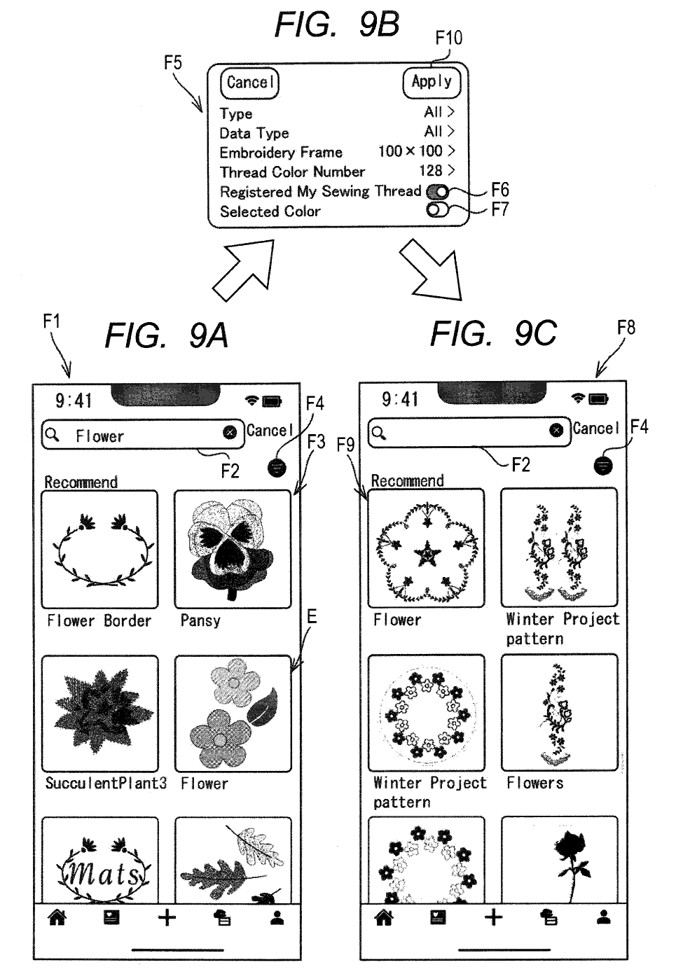

With reference to FIGS. 8 to 9C, a pattern image display process and a pattern image transmission process will be described. The thread color registration device 1 and the server 5 perform these processes in cooperation with each other. The pattern image display process includes receiving pattern image data included in pattern data satisfying an extraction condition from among a plurality of types of pattern data stored in the memory 44 of the server 5, and displaying a pattern image on the display 18 based on the received pattern image data. The pattern image display process is performed by the CPU 6 of the thread color registration device 1. The pattern image display process is performed when a toggle switch F6 of a screen F5 shown in FIG. 9B is set to ON. The toggle switches F6 and F7 are ON when the respective circular switches are on the right side and OFF when the circular switches are on the left side. When the user operates the input interface 19 to select a key image F10 in a state where the toggle switch F6 is ON, the CPU 6 detects a start instruction to start the pattern image display process.

In response to detecting the start instruction, the CPU 6 reads out a program for performing the pattern image display process stored in the program storage area of the memory 14 to the RAM 13. The program includes instructions for causing the CPU 6 to perform the following steps. The CPU 6 performs the following steps according to the instructions included in the program read out to the RAM 13.

The pattern image transmission process includes transmitting, to the thread color registration device 1, pattern image data included in pattern data that satisfies the extraction condition, from among a plurality of types of pattern data stored in the memory 44 of the server 5. The pattern image transmission process is performed by the CPU 41 of the server 5. In response to receiving the registration list 141 in S20, which will be described later, the CPU 41 reads out a program for performing the pattern image transmission process stored in the program storage area of the ROM 42 to the RAM 43. The program includes instructions for causing the CPU 41 to perform the following steps. The CPU 41 of the server 5 performs the following steps according to the instructions included in the program read out to the RAM 43.

The screen F5 of FIG. 9B is displayed in response to detecting selection of the key image F4 included in the screen F1 of FIG. 9A. The screen F5 may be displayed on the screen F1 in an overlapping manner. As shown in FIG. 9A, the screen F1 includes a field F2, a keyword pattern image F3, and a key image F4. The field F2 is a field for inputting a keyword. The keyword pattern image F3 displays pattern images based on pattern image data included in pattern data extracted based on a keyword. The pattern image may be an image in which areas where stitches are formed are filled with the colors of the threads to be used for the sewing. The pattern image may be an image in which line segments indicating stitches are indicated by the colors of the threads to be used for sewing. In the screen F1, the keyword “Flower” is input in the field F2, and pattern images related to the keyword “Flower” are displayed as the keyword pattern image F3. The key image F4 is selected for inputting extraction conditions of pattern data other than a keyword.

As shown in FIG. 9B, the screen F5 includes the toggle switches F6 and F7, and the key image F10. The toggle switch F6 switches whether to specify a condition for extracting a pattern whose pattern colors are indicated by registered colors. When the toggle switch F6 is on the right side, the condition for extracting pattern data indicating a pattern whose pattern colors are indicated by the registered colors is specified. When the toggle switch F6 is on the left side, the condition for extracting pattern data indicating a pattern whose pattern colors are indicated by the registered colors is not specified.

The toggle switch F7 is displayed in the screen F5 when the toggle switch F6 is set to right. The toggle switch F7 is used to switch whether to specify a condition for extracting pattern data indicating a pattern represented by registered colors and one color among unregistered colors. The one color among the unregistered colors may be set as appropriate. The one color among the unregistered colors may be, for example, a color selected from the unregistered colors by the user, or may be a color automatically set in consideration of the registered colors. When the user selects one color from the unregistered colors, the user may check an image indicating the unregistered colors displayed on the display 18 and operate the input interface 19 to select one color.

When the toggle switch F7 is on the right side, a condition for extracting pattern data indicating a pattern represented by registered colors and one color among unregistered colors is specified. As shown in FIG. 9B, when the toggle switch F7 is on the left side, the condition for extracting pattern data indicating a pattern represented by registered colors and one color among unregistered colors is not specified. The key image F10 is selected to input an instruction to extract pattern data satisfying the extraction condition from a plurality of pattern data in accordance with settings in the screen F5.

As shown in FIG. 8, in the pattern image display process, the CPU 6 of the thread color registration device 1 acquires the color list 142 and the registration list 141 stored in the memory 14, and transmits the color list 142 and the registration list 141 to the server 5 (S71). In the pattern image transmission process, the CPU 41 of the server 5 acquires the color list 142 and the registration list 141 transmitted from the thread color registration device 1, and stores the acquired lists in the RAM 43 (S20). The color list 142 and the registration list 141 may be stored in the memory 44 of the server 5 in advance. In this case, the registration list 141 stored in the memory 44 may be updated by communication between the thread color registration device 1 and the server 5 in the list image display process. The color list 142 and the registration list 141 may be stored in advance in both the memory 14 of the thread color registration device 1 and the memory 44 of the server 5.

The CPU 6 of the thread color registration device 1 acquires the extraction condition based on the toggle switch F7, and transmits the extraction condition to the server 5 (S72). The CPU 41 of the server 5 acquires the extraction condition transmitted from the thread color registration device 1 and stores the extraction condition in the RAM 43 (S21). The extraction condition includes a first condition or a second condition. The first condition is selected when the toggle switch F7 is on the left side. The first condition is a condition of extracting pattern data indicating a pattern to be sewn with threads of the registered colors. The second condition is selected when the toggle switch F7 is on the right side. The second condition is a condition of extracting pattern data indicating a pattern to be sewn with threads of the registered colors and one color among the unregistered colors.

The CPU 41 of the server 5 determines whether the extraction condition transmitted from the thread color registration device 1 is the first condition for extracting pattern data indicating a pattern to be sewn with threads of the registered colors (S22). As shown in FIG. 9B, when the extraction condition is the first condition (S22: YES), the CPU 41 sets the registered colors as usable colors based on the registration list 141 stored in the RAM 43 (S23). When the extraction condition is not the first condition (S22: NO), that is, when the extraction condition is the second condition, the CPU 41 sets, as the usable colors, the registered colors and one color among the unregistered colors based on the color list 142 and the registration list 141 stored in the RAM 43 (S24).

The CPU 41 extracts particular pattern data from among the plurality of types of pattern data stored in the memory 44 (S25). In the present embodiment, the CPU 41 extracts pattern data that are related to the keyword of the field F2 from the plurality of types of pattern data stored in the memory 44. The CPU 41 may extract all of the plurality of types of pattern data stored in the memory 44. The CPU 41 acquires pattern data one at a time in a particular acquisition order from the extracted pattern data as target pattern data. The pattern indicated by the target pattern data is referred to as a target pattern. The acquisition order may be set as appropriate, and may be, for example, an order according to the ID of the pattern.

The CPU 41 determines whether all the pattern colors indicating the target pattern are included in the usable colors (S26). All the pattern colors indicating the target pattern are all the colors corresponding to color data included in the target pattern data. More specifically, in S26 after executing S23 (S22: YES), a positive determination is made (S26: YES) in a case where all the pattern colors indicating the target pattern are the registered colors. In S26 after executing S24 (S22: NO), a positive determination is made (S26: YES) in a case where (a) all the pattern colors indicating the target pattern are the registered colors or (b) all the pattern colors indicating the target pattern, except for one color, are the registered colors. When all the pattern colors indicating the target pattern are included in the usable colors (S26: YES), the CPU 41 adds pattern image data included in the target pattern data to the extraction list (S27). The extraction list may be stored in the memory 44 or the RAM 43 of the server 5.

When any of the pattern colors of the target pattern is not included in the usable colors (S26: NO) or after S27, the CPU 41 determines whether the target pattern is the last in the acquisition order (S28). When the target pattern is not the last in the acquisition order (S28: NO), the CPU 41 acquires, as the target pattern data, the next pattern data in the acquisition order from the pattern data extracted in S25 (S29), and returns the processing to S26.

When the target pattern is the last in the acquisition order (S28: YES), the CPU 41 transmits pattern image data included in the extraction list to the thread color registration device 1 (S30). The CPU 41 then ends the pattern image transmission process.

The CPU 6 of the thread color registration device 1 determines whether the pattern image data transmitted from the server 5 has been received (S73). When the CPU 6 has not received the pattern image data transmitted from the server 5 (S73: NO), the CPU 6 returns the processing to S73. When the CPU 6 receives the pattern image data transmitted from the server 5 (S73: YES), the CPU 6 displays a pattern image on the display 18 based on the received pattern image data (S74).

As shown in the screen F8 of FIG. 9C, when the extraction condition is the first condition, the CPU 6 performs a first pattern display process of displaying the first pattern image F9 among the pattern images on the display 18. The screen F8 includes the field F2 and the key image F4 similar to those of the screen F1, and a first pattern image F9. The first pattern image F9 indicates a pattern to be sewn with threads of the registered colors. The user easily selects, from the first pattern image F9, a pattern of colors that the user owns and that are stored in the registration list 141.

When the extraction condition is the second condition, the CPU 6 performs a second pattern display process of displaying a second pattern image among the pattern images on the display 18. The second pattern image indicates a pattern to be sewn with threads of the registered colors and one color among the unregistered colors. The CPU 6 then ends the pattern image display process.

In the pattern image display process, the thread color registration device 1 may perform process of receiving, via the input interface 19, a selection of a pattern to be sewn by the sewing machine 2 from among the patterns indicated by the pattern images displayed in S74. In this case, the thread color registration device 1 may acquire information related to the selected pattern, such as sewing data, from the server 5, and transmit the acquired information to the sewing machine 2. The sewing machine 2 may perform a process of sewing the selected pattern based on the information transmitted from the thread color registration device 1.

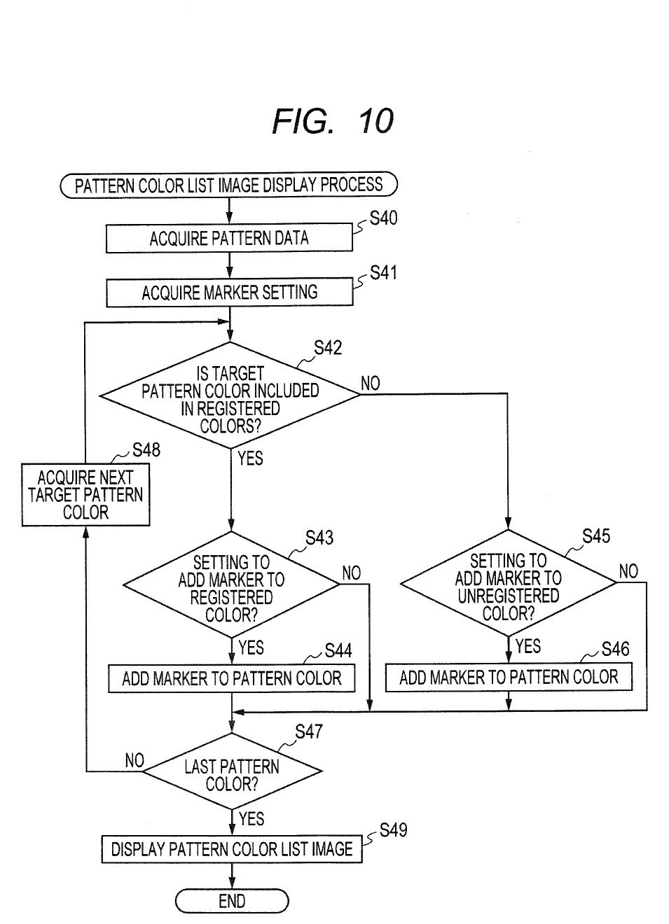

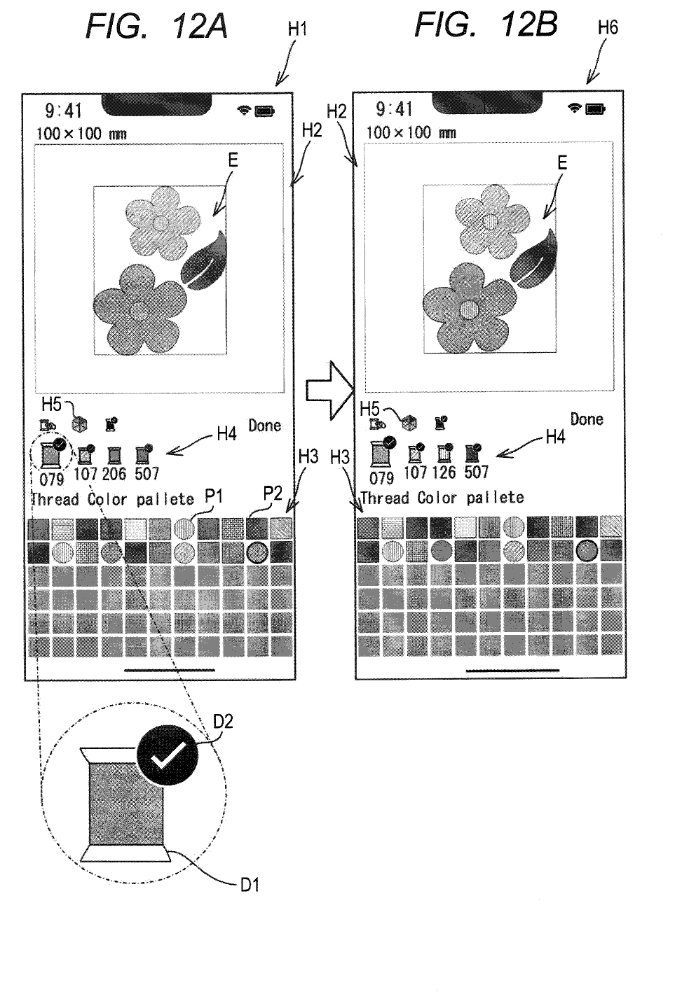

A pattern color list image display process will be described with reference to FIGS. 10 and 12A. The pattern color list image display process is started, for example, in response to detecting a selection of a pattern image E from the keyword pattern images F3 in FIG. 9A. In response to detecting a selection of the pattern image E, the CPU 6 reads out a program for performing the pattern color list image display process stored in the program storage area of the memory 14 to the RAM 13. The program includes instructions for causing the CPU 6 to perform the following steps. The CPU 6 performs the following steps according to the instructions included in the program read out to the RAM 13.

As shown in FIG. 10, in the pattern color list image display process, the CPU 6 acquires pattern data corresponding to the pattern image E. Specifically, the CPU 6 transmits a signal indicating that the pattern image E has been selected to the server 5. The CPU 41 of the server 5 extracts pattern data corresponding to the pattern image E from the plurality of types of pattern data stored in the memory 44 based on the received signal, and transmits the extracted pattern data to the thread color registration device 1. The CPU 6 of the thread color registration device 1 receives and acquires the pattern data from the server 5 (S40). In a case where the memory 14 stores pattern data corresponding to the pattern image E, the CPU 6 may acquire the pattern data corresponding to the pattern image E from the memory 14.

The CPU 6 acquires a marker setting (S41). The marker setting is a setting for adding a marker to the registered colors or a setting for adding a marker to the unregistered colors. When the marker setting is stored in the memory 14, the CPU 6 may acquire the marker setting stored in the memory 14. The CPU 6 may acquire the marker setting selected by the user that operates the input interface 19.

The CPU 6 acquires a target pattern color from pattern colors indicating the pattern corresponding to the pattern image E one at a time, and determines whether the target pattern color is included in the registered colors (S42). The target pattern color may be acquired in order from the pattern colors of the pattern corresponding to the pattern image E, for example, in ascending order of the color number. The CPU 6 determines whether the target pattern color is included in the registered colors by determining whether the color number corresponding to the target pattern color is included in the registration list 141. When the target pattern color is included in the registered colors (S42: YES), the CPU 6 determines whether the setting is to add a marker to the registered color based on the marker setting acquired in S41 (S43).

When the setting is to add a marker to the registered color (S43: YES), the CPU 6 adds a marker to the target pattern color (S44). In the present specification, “adding a marker to the target pattern color” means that a marker icon D2 is arranged near a pattern color icon D1 indicating the target pattern color in the pattern color list image. The memory 14 of the thread color registration device 1 stores the pattern color icon D1 of the colors included in the color list 142, and stores the marker icon D2. The CPU 6 acquires, for example, the pattern color icon D1 indicating a pattern color and the marker icon D2 in S44. The CPU 6 generates the pattern color list image in which the pattern color icons D1 indicating pattern colors are arranged. The CPU 6 arranges the marker icon D2 near the pattern color icon D1 indicating the target pattern color in the pattern color list image. When the setting is not to add a marker to the registered color (S43: NO) or after S44, the CPU 6 performs S47.

When the target pattern color is not included in the registered colors (S42: NO), the CPU 6 determines whether the setting is to add a marker to an unregistered color based on the marker setting acquired in S41 (S45). When the setting is to add a marker to an unregistered color (S45: YES), the CPU 6 adds a marker to the target pattern color (S46). When the setting is not to add a marker to an unregistered color (S45: NO) or after S46, the CPU 6 determines whether the target pattern color is the last pattern color (S47). The pattern colors indicating the patterns corresponding to the pattern images E are acquired in order as the target pattern color, and when no pattern color is acquired anymore, the target pattern color is the last pattern color. When the target pattern color is not the last pattern color (S47: NO), the CPU 6 acquires the next pattern color as the target pattern color (S48), and returns the processing to S42.

When the target pattern color is the last pattern color (S47: YES), the CPU 6 performs a pattern color display process of displaying the pattern color list image on the display 18 (S49). The pattern color list image indicates registered colors and unregistered colors in a distinguishable manner among the pattern colors indicating the patterns to be sewn by the sewing machine 2.

With reference to FIG. 12A, a screen H1 including a pattern color list image H4 will be described by taking, as an example, a case where the marker setting acquired in S41 is a setting for adding a marker to a registered color. In S49, the CPU 6 displays the screen H1 on the display 18. The screen H1 includes a field H2, a list image H3, a pattern color list image H4, and a key image H5. The pattern image E is displayed in the field H2.

The list image H3 displays the colors registered in a thread color palette, separately as registered colors and unregistered colors. The thread color palette includes some of the colors stored in the color list 142. In the list image H3, the registered color is represented by a first icon P1 filled with the registered color. In the list image H3, the unregistered color is represented by a second icon P2 filled with the unregistered color. In the present embodiment, the first icon P1 is circular, and the second icon P2 is square.

The pattern color list image H4 includes a pattern color icon D1 indicating a pattern color and a marker icon D2 disposed near the pattern color icon D1 indicating a registered color among the pattern colors. The pattern color icon D1 is represented by a pattern of the thread spool 80 in a posture in which the axis K of the through hole 87 extends in the vertical direction. The color of the thread of the pattern color icon D1 is represented by the pattern color.

The marker icon D2 indicates that the pattern color indicated by the pattern color icon D1 is a registered color. The marker icon D2 of the present embodiment is a check mark. The diameter of a circle circumscribed about the marker icon D2 is smaller than the diameter of a circle circumscribed about the pattern color icon D1. The marker icon D2 is a pattern that distinguishes between a registered color and an unregistered color.

In the present specification, “near the pattern color icon D1” is a position within a range set based on the size of the pattern color icon D1. Specifically, “near the pattern color icon D1” refers to a range of three times the radius of the circle from the center of the circle circumscribed about the pattern color icon D1. The marker icon D2 may overlap the pattern color icon D1 or may be separated from the pattern color icon D1.

In FIG. 12A, the marker icon D2 is arranged on the upper right of the pattern color icon D1 of the registered color among the pattern colors such that the marker icon D2 indicated by a check mark partially overlaps the pattern color icon D1. A part of the pattern color icon D1 is covered with the marker icon D2. A color number is displayed below the pattern color icon D1. The pattern colors of the color numbers “079”, “107”, and “507” have the marker icon D2 indicating that the pattern colors are registered colors. The pattern color having the color number “206” is an unregistered color to which the marker icon D2 is not added. The key image H5 is selected to input an instruction to start a pattern color replacement process described later.

When the marker setting acquired in S41 is a setting for adding a marker to an unregistered color, the pattern color list image includes the pattern color icon D1 indicating a pattern color and the marker icon D2. The marker icon D2 is arranged near the pattern color icon D1 indicating an unregistered color among the pattern colors. That is, the pattern color of the color number “206” may have the marker icon D2 indicating that the pattern color is an unregistered color. The pattern colors of the color numbers “079”, “107”, and “507” may not have the marker icon D2. The CPU 6 then ends the pattern color display process.

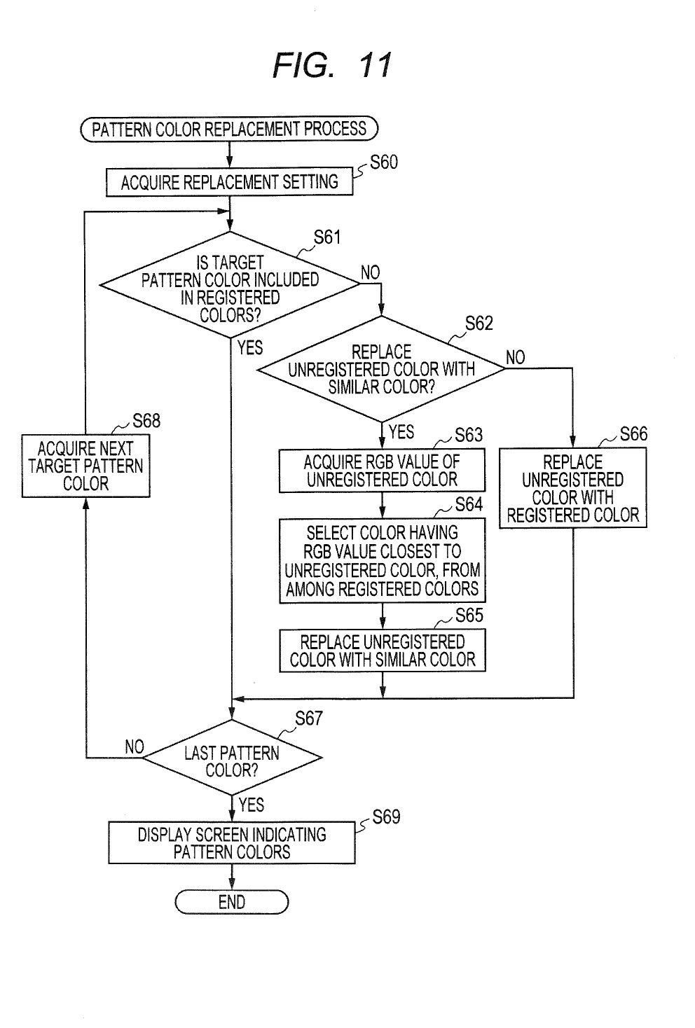

The pattern color replacement process will be described with reference to FIGS. 11, 12A, and 12B. The pattern color replacement process is started when the key image H5 is selected. In response to detecting selection of the key image H5, the CPU 6 reads out a program for performing the pattern color replacement process stored in the program storage area of the memory 14 to the RAM 13. The program includes instructions for causing the CPU 6 to perform the following steps. The CPU 6 performs the following steps according to the instructions included in the program read out to the RAM 13.

As shown in FIG. 11, in the pattern color replacement process, the CPU 6 acquires a replacement setting (S60). The replacement setting is a setting for replacing an unregistered color included in the pattern colors with a registered color, and includes a first replacement setting or a second replacement setting. The first replacement setting is a setting for replacing an unregistered color included in the pattern colors with a certain registered color. The second replacement setting is a setting for replacing an unregistered color included in the pattern colors with a similar color included in the registered colors. The similar color is a color closest to the unregistered color included in the pattern colors among the registered colors.

The CPU 6 acquires a target pattern color from the pattern colors indicating the pattern corresponding to the pattern image E one at a time, and determines whether the target pattern color is included in the registered colors (S61). In a case where the pattern colors indicated by the color numbers “079”, “107”, and “507” are the target pattern colors, the CPU 6 determines that the target pattern colors are included in the registered colors (S61: YES). The CPU 6 determines whether the target pattern color is the last pattern color (S67). When the target pattern color is not the last pattern color (S67: NO), the CPU 6 reads out the next pattern color in the display order as the target pattern color (S68), and returns the processing to S61.

When the pattern color indicated by the color number “206” is the target pattern color, the CPU 6 determines that the target pattern color is not included in the registered colors, that is, the target pattern color is an unregistered color (S61: NO). In this case, the CPU 6 determines whether the setting acquired in S60 is a replacement setting for replacing the unregistered color included in the pattern colors with a similar color included in the registered colors, that is, the second replacement setting (S62). When the setting acquired in S60 is the first replacement setting (S62: NO), the CPU 6 performs a replacement process of replacing the unregistered color included in the pattern colors indicating the pattern to be sewn with a certain registered color (S66).

Specifically, the CPU 6 replaces color data indicating the unregistered color included in the pattern data corresponding to the pattern image E with color data indicating a registered color. The CPU 6 replaces the unregistered color included in the pattern image E with the registered color. The CPU 6 replaces the unregistered color included in the pattern color list image H4 with the registered color. The certain registered color may be randomly selected from the registered colors by the CPU 6. The certain registered color may be selected by the user operating the input interface 19 from among the registered colors displayed on the display 18.

When the setting acquired in S60 is the second replacement setting (S62: YES), the CPU 6 accesses the memory 14 and acquires the RGB value of the target pattern color (S63). The CPU 6 selects a similar color having an RGB value closest to the RGB value of the target pattern color from among the registered colors (S64). For example, the CPU 6 determines, as the similar color, the registered color having the smallest calculation result of Euclidean distances between the RGB value of the target pattern color and the RGB values of the registered colors.

The CPU 6 performs a replacement process of replacing the unregistered color included in the pattern colors indicating the pattern to be sewn, with the similar color included in the registered colors (S65). The CPU 6 of the present embodiment replaces the unregistered color included in the pattern colors with the similar color included in the registered colors in a case where the replacement setting is the second replacement setting. Specifically, the CPU 6 replaces color data indicating the unregistered color included in the pattern data corresponding to the pattern image E with color data indicating the similar color, and thereby replaces the unregistered color included in the pattern image E with the similar color.

When the target pattern color is the last pattern color (S67: YES), the CPU 6 displays a screen showing the pattern colors on the display 18 (S69).

When the replacement setting acquired in S60 is the second replacement setting, the CPU 6 displays a screen H6 on the display 18 as a screen showing the pattern colors. As shown in FIG. 12B, the CPU 6 displays the screen H6 on the display 18. The screen H6 includes the field H2, the list image H3, the pattern color list image H4, and the key image H5, which are similar to the screen H1.

The pattern color icon D1 which is the third from the left in the pattern color list image H4 has been changed from the pattern color icon D1 with the color number “206” to the pattern color icon D1 with the color number “126”. The pattern color icon D1 of the color number “126” has the marker icon D2 indicating that the color is a registered color.

In the pattern image E displayed in the field H2, the color of the flower core is replaced with the color indicated by the color number “126” from the color number “206”. The color indicated by the color number “126” is included in the registered colors, and is the similar color of the color indicated by the color number “206”. When the replacement setting is the second replacement setting, the unregistered color of the pattern image E in the field H2 is replaced with the similar color by the replacement process of S65, and the pattern image E is displayed in the registered colors (without including the unregistered color). The CPU 6 then ends the pattern color replacement process.

The thread color registration device 1 may transmit information, such as sewing data, relating to the pattern in which the unregistered color is replaced with the registered color in the pattern color replacement process to the sewing machine 2. The sewing machine 2 may perform a process of sewing a pattern based on the information transmitted from the thread color registration device 1.

In the above embodiment, the thread color registration system 4 is an example of a thread color registration system of the present disclosure. The thread color registration device 1 is an example of a thread color registration device of the present disclosure. The CPUs 6 and 41 are examples of a processor of the present disclosure. The image sensor 11 is an example of an image sensor of the present disclosure. The memory 14 is an example of a memory of the present disclosure. The display 18 is an example of a display of the present disclosure. The thread spool 80 is an example of a thread spool of the present disclosure. The first thread spool 81 is an example of a first thread spool of the present disclosure. The second thread spool 82 is an example of a second thread spool of the present disclosure. The third thread spool 83 is an example of a third thread spool of the present disclosure. The two-dimensional codes 90 and 901 to 903 are examples of a two-dimensional code of the present disclosure. The registration list 141 is an example of a registration list of the present disclosure. The pattern color icon D1 is an example of a pattern color icon of the present disclosure. The marker icon D2 is an example of a marker icon of the present disclosure. The first icons P1 and Q1 are examples of a first icon. The second icons P2 and Q2 are examples of a second icon.

The processing of S4 is an example of a detection process of the present disclosure. The processing of S14 and S15 is an example of a registration process of the present disclosure. The processing of S18 is an example of a display process of the present disclosure. The processing of S74 is an example of a first pattern display process and a second pattern display process of the present disclosure. The processing of S65 and S66 is an example of a replacement process of the present disclosure. The processing of S13 is an example of a deletion process and an identification information deletion process. The processing of S49 is an example of a pattern color display process of the present disclosure.

The thread color registration device 1 of the above embodiment includes the image sensor 11, the display 18, and the CPU 6. The thread color registration device 1 stores the color of the thread 86 of the thread spool 80 in the registration list 141 stored in the memory 14. The thread color registration program includes instructions for causing the CPU 6 of the thread color registration device 1 to perform the following processing. The CPU 6 performs a detection process of detecting the two-dimensional code 902 by using the image sensor 11 (S4). The CPU 6 performs a registration process of storing a second color, which is a color indicated by the two-dimensional code 902, in the registration list 141 in which a first color, which is a color of the thread 861 of the first thread spool 81, is stored (S15). The second color is the color of the thread 862 of the second thread spool 82 different from the first thread spool 81. The CPU 6 performs a display process of displaying a list image indicating registered colors, which are a plurality of colors stored in the registration list 141, on the display 18 (S18). The registered colors include the first color and the second color.

The detection process and the registration process of the thread color registration program contribute to storing the color of the thread 86 of the thread spool 80 possessed by the user in the registration list 141 more easily and accurately by using the two-dimensional code 90. The display process of the thread color registration program contributes to allowing the user to grasp the colors of the threads 86 of the thread spools 80 possessed by the user and stored in the registration list 141.

The detection process is a process of detecting a plurality of two-dimensional codes 90 (S4). The registration process is a process of storing the second color, which is the color indicated by the two-dimensional code 902, and the third color, which is the color indicated by the two-dimensional code 903, in the registration list 141 (S15). The third color is the color of the thread 863 of the third thread spool 83 different from the first thread spool 81 and the second thread spool 82. The registered colors include the first color, the second color, and the third color. The detection process and the registration process of the thread color registration program contribute to making the operation of collectively storing the colors of the threads 86 of the plurality of thread spools 80 in the memory 14 by using the two-dimensional code 90 easier.

The two-dimensional code 902 indicates the second color and indicates identification information that uniquely identifies the second thread spool 82. The registration process is a process of storing the second color and the identification information of the second thread spool 82 in the registration list 141 in association with each other (S14, S15). The registration process contributes to distinguishing the plurality of thread spools 80 of the same color based on the identification information.

When the identification information of the second thread spool 82 is not stored in the registration list 141 (S11: NO), the CPU 6 performs the registration process (S14). When the identification information of the second thread spool 82 is stored in the registration list 141 (S11: YES), the CPU 6 does not perform the registration process. The registration process of the thread color registration program contributes to registering, in a distinguishable manner, the thread spools 80 of the threads 86 having the same color based on the identification information of the thread spools 80 indicated by the two-dimensional codes 90.

The memory 14 stores unregistered colors, which are colors that are not stored in the registration list 141, among colors that can be stored in the registration list 141. In the display process, the list image that shows registered colors and unregistered colors in a distinguishable manner is displayed on the display 18 (S18). The display process of the thread color registration program contributes to easily distinguishing between the registered colors and the unregistered colors in the list image displayed on the display 18. The thread color registration program contributes to allowing the user to grasp the color of the thread that is not stored in the registration list 141, in addition to the color of the thread that is possessed by the user and that is stored in the registration list 141.

The list image indicates the registered color and the unregistered color by a color number which is a number indicating a color. The display process of the thread color registration program contributes to clearly distinguishing similar colors by color numbers.

The list image shows the background of the color number of the registered color in the registered color and the background of the color number of the unregistered color in gray. The display process of the thread color registration program contributes to easily distinguishing between the registered color and the unregistered color by checking the color of the background of the color number.

The list image indicates the registered color by the first icon Q1 of the registered color and indicates the unregistered color by the second icon Q2. The second icon Q2 is an icon having a shape different from that of the first icon Q1. The list image of the thread color registration program contributes to easily distinguishing between the registered color and the unregistered color by checking the shape of the icon.

The CPU 6 performs the first pattern display process that displays a first pattern image on the display 18, the first pattern image representing a pattern that is sewn with threads of the registered colors (S74). The first pattern display process of the thread color registration program contributes to displaying, on the display 18, patterns that are to be indicated by the plurality of colors stored in the registration list 141.

The CPU 6 performs the second pattern display process for displaying the second pattern image on the display 18 (S74). The second pattern image indicates a pattern to be sewn with threads of the registered colors and one color among the unregistered colors. The unregistered color is a color that is not stored in the registration list 141 among colors that can be stored in the registration list 141. The pattern display process of the thread color registration program contributes to display of patterns that are indicated by adding one more color to the plurality of colors stored in the registration list 141.

The CPU 6 performs the replacement process of replacing the unregistered color included in a pattern image with a registered color, in the pattern image indicating a pattern to be sewn (S65, S66). The unregistered color is a color that is not stored in the registration list among colors that can be stored in the registration list. The replacement process of the thread color registration program contributes to changing the pattern image to a pattern image indicating a pattern to be sewn using the registered color in a case where the pattern image includes an unregistered color.

The replacement process is a process of replacing the unregistered color included in the pattern colors with the similar color (S65). The similar color is a color similar to the unregistered color included in the pattern colors among the registered colors. The replacement process of the thread color registration program enables sewing using the registered color in a case where the pattern color includes an unregistered color, and contributes to changing the pattern to a pattern of a color similar to the pattern before the replacement process is performed.

The CPU 6 performs the pattern color display process of displaying the pattern color list image on the display 18 (S49). The pattern color list image indicates registered colors and unregistered colors in a distinguishable manner among the pattern colors indicating a pattern to be sewn. The pattern color display process of the thread color registration program contributes to making it easy to distinguish between the registered color and the unregistered color among the pattern colors.

The pattern color list image includes the pattern color icon D1 indicating pattern colors and the marker icon D2 indicating a registered color among the pattern colors and disposed near the pattern color icon D1. The pattern color list image displayed when the thread color registration program is performed contributes to making it easy to grasp the registered color among the pattern colors.

When the second color detected in the detection process is not stored in the registration list 141 (S10: NO), the CPU 6 performs a registration process (S15). When the second color detected in the detection process is stored in the registration list 141 (S10: YES), the CPU 6 does not perform the registration process, and performs the deletion process of deleting the second color indicated by the two-dimensional code 90 from the registration list 141 (S13). When the thread 86 wound around the cylindrical body 85 of the thread spool 80 runs out, the color of the thread 86 of the thread spool 80 may not be recognized. In contrast, the deletion process of the thread color registration program contributes to appropriately deleting the color stored in the registration list 141 based on the detected two-dimensional code 90 when the thread 86 wound around the cylindrical body 85 of the thread spool 80 runs out.

When the identification information of the second thread spool 82 is not stored in the registration list 141 (S11: NO), the CPU 6 performs the registration process (S14). When the identification information of the second thread spool 82 is stored in the registration list 141 (S11: YES), the CPU 6 does not perform the registration process, and performs the identification information deletion process of deleting the identification information of the second thread spool 82 from the registration list 141 (S13). The thread color registration program contributes to switching between performing the registration process and performing the identification information deletion process depending on whether the identification information of the second thread spool 82 is stored in the registration list 141. The identification information deletion process of the thread color registration program contributes to appropriately deleting the identification information associated with the color stored in the registration list 141 from the registration list 141 when the thread 86 wound around the thread spool 80 runs out.

While the disclosure has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the disclosure, and not limiting the disclosure. Various changes may be made without departing from the spirit and scope of the disclosure. Thus, the disclosure is intended to embrace all known or later developed alternatives, modifications, variations, improvements, and/or substantial equivalents. Some examples of potential alternatives, modifications, or variations in the described disclosure are provided below.

The thread color registration program, the thread color registration method, and the thread color registration system of the present disclosure are not limited to the above-described embodiment, and various modifications may be made without departing from the scope of the present disclosure. For example, the following modifications may be made as appropriate. The present disclosure may be implemented in various forms, and may be implemented in the form of, for example, a non-transitory computer-readable storage medium storing a thread color registration program, or a thread color registration device.

(A) The configurations of the system 4 and the thread color registration device 1 may be changed as appropriate. The system 4 may include the sewing machine 2, or a multi-needle sewing machine. The thread color registration device 1 may be a general-purpose device having an image sensor, such as a smartphone, a tablet terminal device, or a digital camera, or may be a device dedicated to thread color registration.

The display 18 of the thread color registration device 1 may be omitted. In this case, the system 4 may include a display separately from the thread color registration device 1. The display 18 of the thread color registration device 1 may be any display configured to display an image. The display 18 may be, for example, an organic EL display, a plasma display, a plasma tube array display, or an electronic paper display using electrophoresis. The input interface 19 of the thread color registration device 1 may include a keyboard, a mouse, a joystick in addition to or instead of the touch screen.

The memory 14 of the thread color registration device 1 may store a plurality of types of pattern data. In this case, the CPU 6 of the thread color registration device 1 may perform the processing from S22 to S29 of the pattern image transmission process of FIG. 8, which is performed by the CPU 41 of the server 5. In this case, the server 5 may be omitted. The processing from S22 to S29 of the pattern image transmission process of FIG. 8 may be performed by the sewing machine 2. The system 4 may be able to select which device performs the processing from S22 to S29.

The thread color registration device 1 may omit the memory 14. In this case, the registration list 141 may be stored in a memory of a device different from the thread color registration device 1. The other device may be, for example, the server 5, an external PC, or an external storage device such as a USB memory. The memory storing the registration list may be a nonvolatile memory.

A thread-spool case in which a plurality of thread spools are housed is known. The user purchases a plurality of thread spools at once by purchasing the thread-spool case, and the thread spools are housed and kept in the thread-spool case. A known thread-spool case for storing a plurality of thread spools has a rectangular box shape, and when the thread-spool case is placed on a horizontal surface, the thread-spool case has a box shape with an open top. Each of the plurality of thread spools is housed in the thread-spool case in a posture in which an axis of the cylindrical thread spool is parallel to the horizontal direction so that a user can check the color of the thread spool when the thread spool is taken out from the thread-spool case.

In the known thread-spool case, when the user captures an image of the two-dimensional code arranged on the flange of the thread spool in a state where the plurality of thread spools are housed in the thread-spool case, the user needs to change the posture of the plurality of thread spools from a posture in which the axis K is parallel to the horizontal direction to a posture in which the axis K is perpendicular to the horizontal direction, and then capture an image from directly above the thread-spool case. For example, in a state where the thread-spool case is placed on a desk, it is difficult to capture an image of the plurality of thread spools housed in the thread-spool case while checking the display 18 because the angle of the display 18 is horizontal.

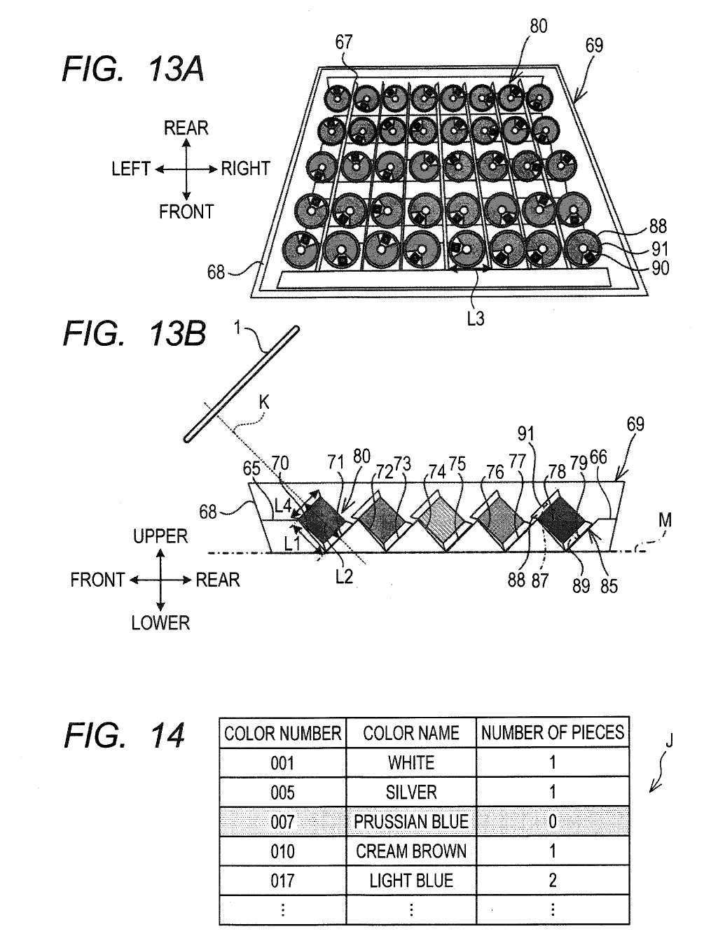

The system 4 may include a thread-spool case 69 shown in FIGS. 13A and 13B. In the following description, the front, rear, left, right, upper, and lower directions shown in FIGS. 13A and 13B are used. The thread-spool case 69 includes a box body 68, placement surfaces 70 to 79, a plurality of partition plates 67, and connecting plates 65 and 66. The box body 68 has a rectangular box shape in plan view with an open top when placed on a horizontal surface M.

Each of the placement surfaces 70 to 79 is a surface that is inclined with respect to the horizontal direction when the thread-spool case 69 is placed on a horizontal surface M. The placement surfaces 70 to 79 are connected in order in the front-rear direction. The placement surfaces 70, 72, 74, 76, 78 are arranged in parallel to each other at equal intervals in the front-rear direction. The placement surfaces 71, 73, 75, 77, 79 are arranged in parallel to each other at equal intervals in the front-rear direction. The placement surfaces 70 to 79 are in a zigzag shape when the entire connected structure is viewed from the left-right direction. A length L1 of each of the placement surfaces 70, 72, 74, 76, and 78 along the inclination direction of the placement surfaces 70, 72, 74, 76, and 78 is shorter than a length L2 of the through hole 87 of the thread spool 80 in the direction in which the axis K extends. That is, when the thread spool 80 is housed in the thread-spool case 69, the imaging of the two-dimensional code 90 on the surface of the thread spool 80 is not hindered by the placement surfaces 70, 72, 74, 76, and 78.

The plurality of partition plates 67 are plates extending in the front-rear direction, and are arranged at equal intervals in the left-right direction in a space surrounded by the box body 68 on four sides. The plurality of partition plates 67 partition, in the left-right direction, a V-shaped groove portion formed by two of the placement surfaces 70 to 79 that are adjacent to each other in the front-rear direction. A distance L3 between the adjacent partition plates 67 in the left-right direction is longer than diameters L4 of the flanges 88 and 89 of the thread spool 80.

The connecting plates 65 and 66 are plates extending in the left-right direction. The front end of the connecting plate 65 is connected to the box body 68, and the rear end of the connecting plate 65 is connected to the upper end of the placement surface 70. The rear end of the connecting plate 66 is connected to the box body 68, and the front end of the connecting plate 66 is connected to the upper end of the placement surface 79.

In the cells partitioned by the partition plates 67, the thread spools 80 are placed in a posture in which the axis K is substantially perpendicular to the placement surfaces 71, 73, 75, 77, and 79. The cell is a space that is determined by the placement surfaces 71, 73, 75, 77, and 79 and the placement surfaces 70, 72, 74, 76, and 78 and in which the thread spool 80 is housed. The flange 89 of the thread spool 80 faces any one of the placement surfaces 71, 73, 75, 77, and 79. The axis K of the thread spool 80 extends substantially parallel to the inclination direction of the placement surfaces 70, 72, 74, 76, 78. The thread-spool case 69 of the present embodiment is configured to store 40 thread spools 80.

With reference to FIG. 13B, an operation of storing the colors of the threads 86 of the plurality of thread spools 80 housed in the thread-spool case 69 in the registration list 141 will be described. The user tilts the thread color registration device 1 with respect to a horizontal plane, and captures an image of the thread spool 80 housed in the thread-spool case 69 in a posture substantially parallel to the flange 88. In this case, the thread color registration device 1 reads the two-dimensional code 90 by the image sensor 11 without changing the posture of the thread spool 80 in a state where the thread spool 80 is disposed in the thread-spool case 69. The CPU 6 detects a maximum of 40 two-dimensional codes 90 in S4.

The thread-spool case 69 of the system 4 contributes to the user visually checking the color of the thread 86 wound around the thread spool 80 in a state where the thread spool 80 is housed in the thread-spool case 69. The user captures an image of the plurality of thread spools 80 housed in the thread-spool case 69 while checking the display 18. The thread-spool case 69 contributes to facilitating an operation of capturing the two-dimensional codes 90 of the thread spools 80.

The configuration of the thread-spool case 69 may be changed as appropriate. The maximum number of thread spools 80 that are housed in the thread-spool case 69 may be one or more. The thread-spool case 69 may not include at least a part of the plurality of partition plates 67. The lengths of the placement surfaces 70 to 79 in the inclination direction and the angle of the inclination directions with respect to the horizontal direction when the thread-spool case 69 is placed on the horizontal surface M may be changed as appropriate. The length L1 may be greater than or equal to the length L2.

(B) The program including instructions for performing the list image display process of FIG. 4, the pattern image display process of FIG. 8, the pattern color list image display process of FIG. 10, and the pattern color replacement process of FIG. 11 may be stored in the memory 14 by the time when the CPU 6 performs the program. Thus, the method of acquiring the program, the acquisition path, and the device that stores the program may be changed as appropriate. The program performed by each device may be received from another device via a cable or wireless communication and stored in a storage device. The other devices include, for example, a PC and a server connected via a network.

(C) The steps of the list image display process of FIG. 4, the pattern image display process of FIG. 8, the pattern color list image display process of FIG. 10, and the pattern color replacement process of FIG. 11 are not limited to the example in which the steps are performed by the CPU 6. Some or all of the steps may be performed by another electronic device such as an ASIC. The other electronic device may be provided in a device other than the thread color registration device 1. Each step may be processed in a distributed manner by a plurality of electronic devices such as a plurality of CPUs. The order of the steps may be changed, and steps may be omitted or added as appropriate. The following changes may be appropriately added to the list image display process of FIG. 4, the pattern image display process of FIG. 8, the pattern color list image display process of FIG. 10, and the pattern color replacement process of FIG. 11.

The information indicated by the list image may be changed as appropriate. The list image may show the registered colors without showing the unregistered colors. When the two-dimensional code 90 of the thread spool 80 indicates the identification information and the identification information is stored in the registration list 141, the CPU 6 may display a list image J shown in FIG. 14 in S18 of FIG. 4. The list image J is a list image corresponding to the registration list 141 shown in FIG. 6D, and indicates the number of the second thread spools 82 corresponding to the number of identification information associated with the second color. The CPU 6 may acquire the number of the second thread spools 82 by measuring (counting) the number of identification information associated with the second color. The CPU 6 may register the number of second colors in the registration list 141 and acquire the number of second colors stored in the registration list 141. The display process of the thread color registration program contributes to the user easily grasping the number of the second thread spools 82. In the list image G7, the CPU 6 may display the number of second colors near the first icon Q1 indicating the second color. The CPU 6 may display the number of second colors instead of the color number. When the second color is selected, the CPU 6 may display the number of the second colors in the field G8.

The method of displaying a registered color and an unregistered color in a distinguishable manner may be changed as appropriate. For example, the second icon Q2 may be colored in the unregistered color instead of gray. In this case, the thread color registration device 1 may display the registered color and the unregistered color in a distinguishable manner, for example, based on the difference in shape between the first icon of the registered color and the second icon of the unregistered color. The icon indicating the registered color and the icon indicating the unregistered color may be in a similarity relationship, and the CPU 6 may display the registered color and the unregistered color in a distinguishable manner by the size of the icons.

The CPU 6 may set the line type of the outline of the icon indicating a registered color and the line type of the outline of the icon indicating an unregistered color to be different from each other, thereby displaying the registered color and the unregistered color in a distinguishable manner. The CPU 6 may represent the registered color by an icon filled with the registered color, and may represent the unregistered color by an icon having an outline of the unregistered color and filled with a particular color such as gray.

The registered colors and the unregistered colors in the list image and the pattern color list image may be indicated by color names, and may not be indicated by color numbers. In this case, as in the list image J shown in FIG. 14, in S18 the CPU 6 may display the registered color and the unregistered color in a distinguishable manner by indicating the background of the color name of the unregistered color in a particular color such as gray.

The storage format of the registered color and the unregistered color in the memory 14 may be changed as appropriate. For example, the registered color and the unregistered color may be distinguished by a flag given to the color list 142 storing the registered colors and the unregistered colors. In this case, the color list 142 including the flag corresponds to the registration list. The memory 14 may store the registered colors without storing the color list and the registration list. In this case, the memory storing the registered colors corresponds to the registration list. The storage format of the registered color is not limited to the format of the present embodiment as long as the registered color is distinguishable by the CPU 6 from other colors such as the unregistered color.

The memory 14 may store an unregistered color list which is separate from the registration list 141 and the color list 142, and may register unregistered colors in the unregistered color list. In this case, when the registered color list is updated, the unregistered color list is updated as appropriate. The color list and the unregistered color list may be stored, and the registration list may not be stored. In this case, the registered colors may be derived based on the color list and the unregistered color list.

In the registration list 141, the identification information need not be stored as long as the information for specifying the color of the thread 86 of the thread spool 80 is stored. The registration list 141 may store one or more types of information selected from a color number, identification information, an RGB value, and a color name.

The processing of S1 and S11 to S13 in the list image display process of FIG. 4 may be omitted as appropriate. The CPU 6 may omit S1 and may perform S13 when the identification information is already stored in the registration list 141 (S11: YES). The CPU 6 may omit S12, and when the color indicated by the detected two-dimensional code 902 is the registered color (S10: YES), the CPU 6 may perform a deletion process of deleting the color number of the detected color from the registration list 141.

Each of the pattern image display process of FIG. 8, the pattern color list image display process of FIG. 10, and the pattern color replacement process of FIG. 11 may be omitted or changed as appropriate. The extraction condition regarding the usable color may not be settable (changeable). In this case, the processing from S21 to S24 may be omitted. For example, the number, arrangement, and size of patterns included in the pattern image displayed in S74 may be changed as appropriate.

The pattern data may be changed as appropriate, and may include, for example, a pattern name. The pattern data may not include the sewing data or the pattern image data. The CPU 6 may perform various processes by identifying the pattern color using the color data of each pixel included in the pattern image data. The pattern image data may be generated by the thread color registration device 1 based on the sewing data.

In S24, the CPU 6 may display a particular number of registered colors on the display 18 as candidates for the similar color in order of similarity to the pattern color. The order of similarity to the pattern color is, for example, the ascending order of the calculation result of the Euclidean distance between the RGB value of the target pattern color and the RGB value of the registered color. In this case, the CPU 6 may set a color selected by the user from among the particular number of candidates as the similar color.

The method of determining the similar color may be set as appropriate. The CPU 6 may use color references such as CMYK values and HSV values instead of the RGB values to determine the similar color. The thread color registration device 1 may store a similar color list in the memory 14 in advance. The similar color list may store a plurality of similar colors in association with each other. The CPU 6 may use another color difference formula instead of the Euclidean distances of the RGB values to determine the similar color.

The pattern color list image may not include the pattern color icon D1 and the marker icon D2. The shape, size, color, and arrangement of the pattern color icon D1 and the marker icon D2 may be changed as appropriate. The CPU 6 may not receive the setting of whether to add the marker icon D2 to the unregistered color or to the registered color, and may add the marker icon D2 to a predetermined one of either the pattern color icon D1 indicating the unregistered color or the pattern color icon D1 indicating the registered color. The CPU 6 may add a first marker icon indicating the unregistered color to the pattern color icon D1 of the unregistered color, and the CPU 6 may add a second marker icon indicating the registered color to the pattern color icon of the registered color. The CPU 6 may set the pattern color icon of the registered color as a first icon, and set the pattern color icon of the unregistered color as a second icon having a shape or size different from that of the first icon.

What is claimed is:

1. A non-transitory computer-readable storage medium storing a thread color registration program including a set of program instructions for a thread color registration device comprising an image sensor, a display, and a processor, the set of program instructions, when executed by the processor, causing the thread color registration device to perform:
detecting a two-dimensional code by the image sensor;
in a registration list storing a first color of a first thread spool, storing a second color of a second thread spool different from the first thread spool, the second color being indicated by the two-dimensional code, the registration list being stored in a memory; and
displaying a list image on the display, the list image indicating registered colors that are a plurality of colors stored in the registration list, the registered colors including the first color and the second color.

2. The non-transitory computer-readable storage medium according to claim 1, wherein the detecting includes detecting a plurality of two-dimensional codes;
wherein the storing includes storing the second color and a third color in the registration list, the second color and the third color being indicated by the plurality of two-dimensional codes, the third color being a color of a third thread spool different from the first thread spool and the second thread spool; and
wherein the registered colors include the first color, the second color, and the third color.

3. The non-transitory computer-readable storage medium according to claim 1, wherein the two-dimensional code further indicates identification information that uniquely identifies the second thread spool; and
wherein the storing includes storing, in the registration list, the second color and the identification information of the second thread spool in association with each other.

4. The non-transitory computer-readable storage medium according to claim 3, wherein the set of program instructions, when executed by the processor, causes the thread color registration device to perform:
storing the second color and the identification information of the second thread spool in a case where the identification information of the second thread spool is not stored in the registration list; and
not storing the second color and the identification information of the second thread spool in a case where the identification information of the second thread spool is stored in the registration list.

5. The non-transitory computer-readable storage medium according to claim 1, wherein the memory further stores an unregistered color, the unregistered color being a color that is not stored in the registration list among colors to be stored in the registration list; and
wherein the displaying includes displaying the list image on the display, the list image indicating the registered color and the unregistered color in a distinguishable manner.

6. The non-transitory computer-readable storage medium according to claim 5, wherein the list image indicates the registered color and the unregistered color by a color number, the color number being a number indicating a color.

7. The non-transitory computer-readable storage medium according to claim 6, wherein, in the list image, a background of the color number of the registered color is shown in the registered color; and
wherein, in the list image, a background of the color number of the unregistered color is shown in gray.

8. The non-transitory computer-readable storage medium according to claim 5, wherein the list image indicates the registered color by a first icon shown in the registered color; and
wherein the list image indicates the unregistered color by a second icon having a different shape from the first icon.

9. The non-transitory computer-readable storage medium according to claim 1, wherein the set of program instructions, when executed by the processor, causes the thread color registration device to further perform:
displaying a first pattern image on the display, the first pattern image indicating a pattern to be sewn by threads of the registered colors.

10. The non-transitory computer-readable storage medium according to claim 9, wherein the set of program instructions, when executed by the processor, causes the thread color registration device to further perform:
displaying a second pattern image on the display, the second pattern image indicating a pattern to be sewn by threads of the registered colors and one color among unregistered colors, the unregistered colors being colors that are not stored in the registration list among colors to be stored in the registration list.

11. The non-transitory computer-readable storage medium according to claim 1, wherein the set of program instructions, when executed by the processor, causes the thread color registration device to further perform:
replacing an unregistered color included in a pattern image with the registered color, the pattern image indicating a pattern to be sewn, the unregistered color being a color that is not stored in the registration list among colors to be stored in the registration list.

12. The non-transitory computer-readable storage medium according to claim 11, wherein the replacing includes replacing the unregistered color included in the pattern image with a similar color, the similar color being a color that is similar to the unregistered color, the similar color being one of the registered colors.

13. The non-transitory computer-readable storage medium according to claim 1, wherein the set of program instructions, when executed by the processor, causes the thread color registration device to further perform:
displaying a pattern color list image on the display, the pattern color list image indicating pattern colors used in a pattern to be sewn, the pattern colors including the registered colors and unregistered colors, the unregistered colors being not stored in the registration list among colors to be stored in the registration list, the registered colors and the unregistered colors being displayed in a distinguishable manner.

14. The non-transitory computer-readable storage medium according to claim 13, wherein the pattern color list image includes:
a pattern color icon indicating each of the pattern colors; and
a marker icon indicating each of the registered colors among the pattern colors, the marker icon disposed near the pattern color icon.

15. The non-transitory computer-readable storage medium according to claim 1, wherein the set of program instructions, when executed by the processor, causes the thread color registration device to perform:
storing the second color in the registration list in a case where the second color is not stored in the registration list; and
deleting the second color from the registration list in a case where the second color is stored in the registration list.

16. The non-transitory computer-readable storage medium according to claim 3, wherein the set of program instructions, when executed by the processor, causes the thread color registration device to perform:
storing the second color and the identification information of the second thread spool in a case where the identification information of the second thread spool is not stored in the registration list; and
deleting the identification information of the second thread spool from the registration list in a case where the identification information of the second thread spool is stored in the registration list.

17. The non-transitory computer-readable storage medium according to claim 16, wherein the second thread spool includes one or more second thread spools; and
wherein the list image further indicates a number of the one or more second thread spools, the number of the one or more second thread spools corresponding to a number of the identification information associated with the second color.

18. A thread color registration method of registering a color of a thread spool, the method comprising:
detecting a two-dimensional code by an image sensor;
in a registration list storing a first color of a first thread spool, storing a second color of a second thread spool different from the first thread spool, the second color being indicated by the two-dimensional code, the registration list being stored in a memory; and
displaying a list image on a display, the list image indicating registered colors that are a plurality of colors stored in the registration list, the registered colors including the first color and the second color.

19. A thread color registration system comprising:
a first thread spool;
a second thread spool different from the first thread spool, the second thread spool having a two-dimensional code;
a memory configured to store a registration list for registering colors of threads of thread spools;
an image sensor;
a display; and
a processor configured to:
detect the two-dimensional code by the image sensor;
in a registration list storing a first color of the first thread spool, store a second color of the second thread spool, the second color being indicated by the two-dimensional code; and
display a list image on the display, the list image indicating registered colors that are a plurality of colors stored in the registration list, the registered colors including the first color and the second color.

20. The thread color registration system according to claim 19, further comprising a thread-spool case having a placement surface, the placement surface being inclined relative to a horizontal surface in a state where the thread-spool case is placed on the horizontal surface,
wherein the second thread spool is placed on the placement surface when the second thread spool is housed in the thread-spool case; and
wherein the processor is configured to detect the two-dimensional code of the second thread spool in a state where the second thread spool is housed in the thread-spool case.
